(19) United States
(12) Patent Application Publication
(10) Pub. No.: US 2015/0189903 A1
(43) Pub. Date: Jul. 9, 2015

(54) Low Surface Oil Potato Chip and Manufacture Thereof

(71) Applicants: Michael Alfred James Spurr, Leicester (GB); Naomi Jane Clark, Nottingham (GB); David John Roberts, Gwynedd (GB); Oliver Herbert, Nottingham (GB); Richard Andrew Bailey, Leicestershire (GB); Brian Richard Newberry, Leicester (GB); Barbara Louise Warburg, Warwickshire (GB); Lindsay Anne Dobson, Oxfordshire (GB); Paul Fredrick Tomlinson, Leicestershire (GB); Glynn R. Bartlett, Boerne, TX (US)

(72) Inventors: Michael Alfred James Spurr, Leicester (GB); Naomi Jane Clark, Nottingham (GB); David John Roberts, Gwynedd (GB); Oliver Herbert, Nottingham (GB); Richard Andrew Bailey, Leicestershire (GB); Brian Richard Newberry, Leicester (GB); Barbara Louise Warburg, Warwickshire (GB); Lindsay Anne Dobson, Oxfordshire (GB); Paul Fredrick Tomlinson, Leicestershire (GB); Glynn R. Bartlett, Boerne, TX (US)

(21) Appl. No.: 13/982,463

(22) PCT Filed: Jan. 27, 2012
(86) PCT No.: PCT/EP2012/051342

§ 371 Date: Mar. 3, 2014

(30) Foreign Application Priority Data
Jan. 31, 2011 (GB) 1101627.6

(51) Int. Cl. A23L 1/217; A23L 1/01; A23L 1/025

(52) U.S. Cl. CPC A23L 1/217; A23L 1/0255; A23L 1/0107; A23V 2002/00

(57) ABSTRACT

A potato chip comprising a cooked potato slice and from 5 to 20 wt % oil based on the weight of the potato chip, wherein the oil comprises a first oil portion within the cooked potato slice and a second oil portion on the surface of the cooked potato slice, the second oil portion comprising no more than 0.2 wt % of the weight of the potato chip.

### CROSS-REFERENCE TO RELATED APPLICATIONS

This application is a 371 National Stage application claiming priority to PCT Application No. PCT/EP2012/051342 filed Jan. 27, 2012, which claims priority to Great Britain Application No. 1101627.6 filed Jan. 31, 2011, now GB Patent No. 2481272 issued May 23, 2012, the technical disclosures of which are hereby incorporated by reference.

### BACKGROUND OF THE INVENTION

### Technical Field

This invention relates to a low surface oil potato chip, and to a method of determining the oiliness of a potato chip. This invention also relates to a method of manufacturing a potato chip.

It has been known for many years to produce potato chips from slices of potato which are fried in oil, usually vegetable oil. Typical conventional potato chips have an oil content of about 30 to 35 wt % oil, based on the total weight of the potato chip. Potato chips exhibit specific organoleptic properties, in combination with visual appearance, to the consumer. The consumer desirous of purchasing a potato chip has a clear expectation of these product attributes in the product.

There is a general desire among snack food manufacturers, consumers and regulatory authorities for healthier food products. In the snack food industry, this has led to a desire for lower fat products. However, even though there may be a general consumer awareness of the benefits of eating lower fat versions of, or alternatives to, existing snack food products, the consumer generally requires the product to have desirable attributes such as texture and flavour. Even if a snack food product is produced which has high nutritional attributes, unless it also has the texture and flavour required by the consumer, the product would not successfully provide the consumer with an acceptable product to replace previous, less healthy snack food products. The challenge among snack food manufacturers is to produce nutritional or more healthy foods which provide the consumer with an improved taste and sensation experience, or at the very least do not compromise on taste and sensation as compared to the consumer's expectation for the particular product or class of products purchased.

Also, for snack foods which are cooked in oil, the consumer generally desires the product not to deposit excessive oil on to the fingers when the snack food is eaten.

There are in the market so-called lower oil snack food products, including potato chips and other products. Some of these processes are produced by modified frying processes using different frying temperatures than those conventionally employed, or cooking processes other than frying, such as baking. Some of these products produce snack foods with low oil, even as low as 5 wt %, but the snack food product is not regarded by the consumer to be an acceptable alternative to a potato chip, because the product cannot exhibit the organoleptic properties, in combination with the visual appearance, of a potato chip.

Also known are potato chips having a thicker slice than conventional 1 to 1.5 mm thick potato chips which may be subjected to controlled frying and/or post fry to provide de-oiled potato chips which can have as low as 21% oil by weight. However, such products typically differ in flavour and/or texture from conventional chips.

In addition, the micro-structure of potato chips, even low oil potato chips, can hold a significant proportion of the oil at the surface, for reasons of chip structure which is formed as a result of the dehydration process used. This is a particular problem for non-fried crisps.

WO-A-2008/011489 and WO-A-2009/091674 in the name of Frito-Lay Trading Company GmbH disclose processes for making a healthy snack food. In those processes, a snack food is made so as to have an appearance and taste similar to conventional fried snack products, such as a potato chip. The potato slices are subjected to a sequence of steps which avoids frying of the slices in oil, and the result is a low fat potato chip.

However, there is still a need for a low fat potato chip which has organoleptic properties, in combination with the visual appearance, of a potato chip, and additionally is combined with other consumer benefits, such as a less oily surface.

### SUMMARY OF THE INVENTION

The present invention accordingly provides a potato chip comprising a cooked potato slice and from 5 to 20 wt % oil based on the weight of the potato chip, wherein the oil comprises a first oil portion within the cooked potato slice and a second oil portion on the surface of the cooked potato slice, the second oil portion comprising no more than 0.2 wt % of the weight of the potato chip.

The present invention further provides a bag of potato chips, wherein the bag comprises a sealed bag of flexible material and contains a plurality of potato chips, each potato chip comprising a cooked potato slice and from 5 to 20 wt % oil based on the weight of the potato chip, wherein an inside surface of the bag has oil deposited thereon by transfer from a portion of the oil on the surface of the cooked potato slices, the weight of oil on the inside surface being no more than 100×10⁻⁶ grams/cm² of the inside surface.

The present invention still further provides a bag of potato chips, wherein the bag comprises a sealed bag of flexible material and contains a plurality of potato chips, each potato chip comprising a cooked potato slice and from 5 to 20 wt % oil based on the weight of the potato chip, wherein an inside surface of the bag has oil deposited thereon by transfer from a portion of the oil on the surface of the cooked potato slices and from 0.1 to 0.5 wt % of the total oil content of the potato chips is on the inside surface.

The present invention yet further provides a method of measuring the surface oil of a potato chip, the method comprising the steps of:
(a) providing a known mass of potato chips;
(b) providing a known mass of a tissue material;
(c) disposing the potato chips as a layer on a layer of the tissue material to form an assembly of layers;
(d) applying a uniform pressure to the assembly of layers;
(e) removing the potato chips from the tissue material; and
(f) weighing the tissue material to determine a weight of oil deposited onto the tissue material from the potato chips.

The present invention still further provides a method of measuring oil deposited on an inside surface of a bag containing potato chips, wherein an inside surface of the bag has oil deposited thereon by transfer from a portion of the oil on a surface of the potato chips, the method comprising the steps of:
(g) providing a sealed bag of flexible material which contains a plurality of potato chips, each potato chip comprising a cooked potato slice and oil;
(h) opening the bag and removing the potato chips;
(i) wiping a known surface area of the inside surface of the bag with a swab of a material to transfer oil from the inside surface to the swab;
(j) extracting oil from the swab;
(k) determining the weight of the extracted oil; and
(l) calculating the weight of oil per unit area of the inside surface.

The present invention yet further provides a method of measuring oil deposited on an inside surface of a bag containing potato chips, the method comprising the steps of:

providing a first sample of a transparent or translucent flexible material;

determining the light transmissivity of the first sample under a predetermined set of illumination and light transmission measuring conditions to provide a first baseline transmissivity value of the flexible material;

determining the light transmissivity of a second sample of the same transparent or translucent flexible material which had previously been used as a bag to package potato chips and the bag having residue oil from the potato chips deposited on one inside surface thereof, the determining being under the same predetermined set of illumination and light transmission measuring conditions as for the first sample and providing a second transmissivity value of the flexible material coated with the oil; and

comparing the first and second transmissivity values to measure an amount of the oil deposited on the inside of the bag.

The present invention yet further provides a method of manufacturing potato chips, the method comprising the steps of:
(m) conveying potato slices through a reservoir of oil contained in a tank, the potato slices being conveyed using an elongate conveyor defining therealong a plurality of compartments for containing respective groups of potato slices;
(n) injecting oil into the reservoir from at least one oil jet located on the tank, the injected oil causing turbulent flow in the reservoir of oil and agitation of the potato slices in the oil;
(o) removing the potato slices from the reservoir of oil;
(p) removing surface oil from the potato slices;
(q) conveying the potato slices through a flat bed microwave apparatus, the microwave apparatus being configured to define a plurality of successive independent microwave zones between the upstream and downstream ends of the microwave apparatus, each zone having a respective microwave attenuator at an upstream inlet and at a downstream outlet of the respective zone;
(r) preheating the potato slices in a first preheating zone located towards an upstream end of the microwave apparatus, the first zone having a first microwave power value;
(s) explosively dehydrating the products in at least one second explosive dehydration zone located downstream of the first preheating zone, the explosive dehydration drying a body of the potato slices at a first drying rate, the second zone having a second microwave power value higher than the first microwave power value; and
(t) drying the potato slices in a third drying microwave zone located downstream of the at least one second explosive dehydration zone.

Preferred features are defined in the dependent claims.

The present invention is predicated on the finding by the inventors that a potato chip can be produced which has a microstructure which is light and porous due to a particular pre-treatment and dehydration mechanism, even without frying, allowing the bulk of the oil to be contained within the chip, away from the surface.

The result is a potato chip which has a novel oil distribution, and a lower proportion of oil at the surface, as well as reduced tendency for oil to be transferred from the body to the surface by contact of the surface. Accordingly, less oil is on the surface and available to be transferred from the surface onto a contacting surface.

The practical effect is that the potato chips of the invention exhibits reduced transfer of oil from the surface onto the fingers of a consumer and onto the interior of packaging such as a flexible bag. This is a significant technical advance over known potato chips.

The finding that packaged potato chips have reduced oil deposition, by transfer of oil from the potato chips onto the interior surface of the packaging, than known packaged potato chips provides the further technical advantages of reduced oil wastage and improved package recycling. In addition, such reduced oil deposition enables the potato chips to be packaged in a transparent package, such as a flexible bag, and still have consumer acceptance. In the past, potato chips have generally not been packaged in transparent bags because the excess deposited oil on the inside surface of the bag was unsightly and emphasised the high oil content of the product to the consumer.

### BRIEF DESCRIPTION OF THE DRAWINGS

An embodiment of the present invention will now be described, by way of example only, with reference to the accompanying drawings in which:

FIG. 1 is a schematic cross-section through a potato chip according to a first embodiment of the present invention;

FIG. 2 is a schematic exploded side view of an assembly for use in the method of measuring the surface oil of a potato chip according to a second embodiment of the present invention;

FIG. 3 is a schematic perspective view of a partly opened bag of potato chips according to a third embodiment of the present invention;

FIG. 4 is a schematic plan view of a swabbing step used in the method of measuring the deposited oil on the inside surface oil of a bag of potato chips according to a fourth embodiment of the present invention;

FIG. 5 shows the amount of surface oil collected on a tissue for each of Example 1 and Comparative Examples 1 to 4;

FIG. 6 shows the amount of oil collected per unit area of the inside surface of the bag for each of Example 2 and Comparative Examples 5 to 8;

FIG. 7 is a schematic flow chart of a manufacturing process for potato chips according to an embodiment of the present invention;

FIG. 8 is a schematic partly cut-away side view of an apparatus for lipophilically pre-conditioning potato slices according to an embodiment of the present invention;

FIG. 9 is a schematic partly cut-away plan view of the apparatus of FIG. 8;

FIG. 10 is a schematic perspective view of a flume in an apparatus for separating potato slices according to an embodiment of the present invention;

FIG. 11 is a schematic plan view of the flume of FIG. 10;

FIG. 12 is a schematic section on line A-A in FIG. 11;

FIG. 13 is a schematic side view of an apparatus for de-oiling potato slices according to an embodiment of the present invention; and

FIG. 14 is a schematic perspective view of a dehydration apparatus including a microwave apparatus according to an embodiment of the present invention.

### DETAILED DESCRIPTION OF THE INVENTION

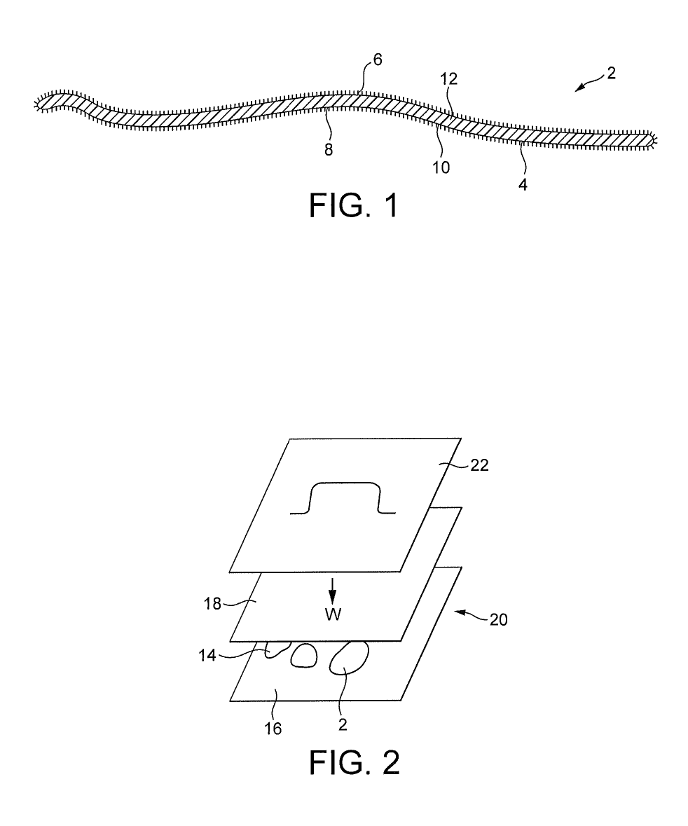

An embodiment of a potato chip according to one aspect of the present invention is illustrated in FIG. 1. The potato chip 2 comprises a cooked potato slice 4. The potato chip 2 has been at least partly cooked in oil, typically vegetable oil such as sunflower oil, conventionally used for manufacturing potato chips. The oil content is from 5 to 20 wt % oil based on the weight of the potato chip 2. Typically, the potato chip 2 comprises from 10 to 17.5 wt % oil, more typically about 15 wt % oil, based on the weight of the potato chip 2.

The oil comprises a first oil portion 6 (schematically illustrated in FIG. 1) within the cooked potato slice 4 and a second oil portion 8 (also schematically illustrated in FIG. 1) on the surface 10 of the cooked potato slice 4. A quantification of the amount of the second oil portion 8 is determined by the test disclosed herein.

The second oil portion 8, i.e. the free surface oil in the potato chip 2, comprises no more than 0.2 wt % of the weight of the potato chip 2, optionally from 0.05 to 0.2 wt %, further optionally from 0.05 to 0.15 wt %, still further optionally about 0.1 wt %, each of the weight of the potato chip 2.

The oil distribution between, on the one hand, the body 12 of the potato chip 2, and, on the other hand, the surface 10 of the chip 2 as free oil, is such that the first oil portion 6 comprises more than 99 wt % of the total oil content of the potato chip 2 and the second oil portion 8 comprises less than 1 wt % of the total oil content of the potato chip 2. Typically, the first oil portion 6 comprises from 99.25 to 99.75 wt % of the total oil content of the potato chip 2 and the second oil portion 8 comprises from 0.25 to 0.75 wt % of the total oil content of the potato chip 2.

According to another aspect of the present invention, there is provided a method of measuring the surface oil of a potato chip. The method is schematically illustrated in FIG. 2.

The method comprises an initial step of providing a known mass of potato chips 2, typically from 3 to 10 grams of potato chips. The potato chips 2 are disposed in the form of a central layer 14 between opposed first and second layers 16, 18 of tissue material to form an assembly of layers 20. The central layer 14 of potato chips 2 typically comprises a plurality of non-overlapping potato chips 2. Typically the tissue material comprises paper tissue. The tissue material has a known mass.

In a modified embodiment, only a single lower layer of tissue material is employed beneath the layer of potato chips 2.

A uniform pressure, from applied weight W, is applied to the assembly of layers 20, for example by a flat weight 22 disposed on the assembly of layers 20. For example, the flat weight 22 has a mass of from 2 to 2.5 kg, such as 2.3 kg.

The applied pressure causes surface oil on the potato chips 2 to be transferred and absorbed onto the first and second layers 16, 18 of tissue material. Thereafter, the potato chips 2 are removed from the tissue material. Finally, the tissue material is weighed to determine a weight of oil deposited onto the tissue material from the potato chips 2.

For each variety of potato chips to be tested, the variety may be divided into a number of samples, and then the samples may be tested individually. For example, the steps may be repeated on at least ten samples of the potato chips to obtain an average weight per sample of potato chips of oil deposited onto the tissue material from the potato chips.

In the tissue testing method used in this specification, the weight was 2316.79 g in weight. The weight was composed of a stainless steel body having dimensions of 198 mm long×149 mm wide and 9 mm thick. Such a weight provides that the potato chips were flattened so that all of the surface area of the potato chips was in contact with the tissue, but the potato chips were not crushed.

The tissue comprised a single-ply rolled tissue material available in commerce from Kimberley-Clark Europe, under the product name Wypall® L30 Wipers (Kimberley-Clark Europe Product ID CDS 07303010). The tissue material had a basis weight of 50 g/m² and an oil absorbency capacity of 200 g/m², and an average thickness of 0.3 mm. The tissue material is provided in sheet form having sheet dimensions of 38 cm×20.6 cm. The tissue has a textured side and an untextured side.

During the test, which was carried out at room temperature (20° C.), a sheet of tissue was preliminarily weighed and its weight recorded. Then one end half of the weighed tissue sheet was placed on a planar upper surface of a platen of a digital weighing scale with the textured side of the tissue uppermost. Then the potato chips were placed on the upper surface of the tissue and over the platen of the weighing scale. The other end half of the tissue sheet was folded over to cover the upper surface of the potato chips on the weighing scale, with the textured side of the other end half contacting the upper surface of the potato chips. Then the weight was placed on the upper surface of the other end half of the tissue sheet to flatten all of the potato chips between the two plies of the tissue. The potato chips and the weight were within the periphery of the platen of the weighing scale, and the potato chips were all between the two tissue plies and covered by the weight.

The flattening was carried out for a period of 15 seconds, after which the weight was removed. The tissue was shaken vigorously to remove any crumbs or debris, and then any remaining debris was blown off using compressed air. The tissue was then weighed and its weight recorded.

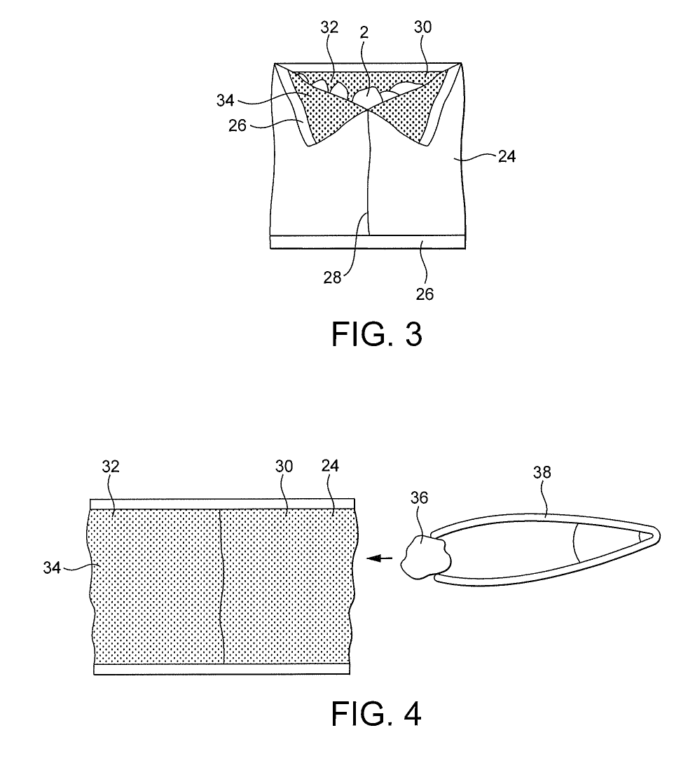

In accordance with a further aspect of the present invention, as shown in FIG. 3, a bag of potato chips comprises a bag 24 of flexible polymeric material 24 (or other material such as paper) and contains a plurality of potato chips 2. The bag 24 may be formed of transparent material. Each potato chip 2 comprises a cooked potato slice and includes from 5 to 20 wt % oil based on the weight of the potato chip 2. The bag 24 is initially sealed, as conventional, with opposed end seals 26 and a longitudinal seal 28 An inside surface 30 of the bag 24 has oil 32 (schematically illustrated in FIG. 3) deposited thereon, by transfer from a portion of the oil on the surface of the potato chips 2. The oil 32 typically comprises a coherent film but may include droplets. The weight of oil 32 on the inside surface 30 is no more than 100×10⁻⁶ grams/cm² of the inside surface 30. Typically, the weight of oil on the inside surface is from 5×10⁻⁶ to 50×10⁻⁶ grams/cm² of the inside surface, more typically from 10×10⁻⁶ to 25×10⁻⁶ grams/cm² of the inside surface 30.

Typically, from 0.1 to 0.5 wt %, more typically from 0.15 to 0.25 wt %, of the total oil content of the potato chips 2 is on the inside surface 30.

According to another aspect of the present invention, there is provided a method of measuring oil 32 (schematically illustrated in FIG. 4) deposited on an inside surface 30 of the bag 24 containing potato chips 2. The method is schematically illustrated in FIG. 4. The inside surface 30 of the bag 24 has oil 32 deposited thereon, typically as a coherent layer, which may include droplets, by transfer from a portion of the oil 32 on a surface of the potato chips 2 contained within the bag 24.

The method comprises the steps of providing a sealed bag 24 of flexible material 34 which contains a plurality of potato chips 2, as shown in FIG. 3. The flexible material 34 may comprise a polymer or paper. Each potato chip 2 comprises a cooked potato slice and oil. The bag 24 is opened and the potato chips 2 are removed. The bag 24 is fully opened to expose the entire inside surface 30 of the bag 24. Then a known surface area of the inside surface 30, typically the entire inside surface 30, is wiped with a swab 36 of a material, such as cotton wool, to transfer oil from the inside surface 30 to the swab 36. The swab 36 may be held by tweezers 38.

Then, using a Soxtec extraction method well known to those skilled in the art of measuring the amount of oil and/or fat in a test material, the oil was extracted from the swab 6 and then the extracted oil was weighed, or the swab was weighed and compared to the original swab weight and the weight of the extracted oil determined. The weight of the oil and the known surface area of the inside surface 30 were then employed to calculate the weight of oil per unit area of the inside surface 30.

Typically, the inside surface 30 is wiped a plurality of times in succession, each time with a respective swab 36, and in the final calculation the weight of the extracted oil comprises the total weight extracted from the plurality of swabs 36.

The method steps may be repeated on at least ten samples of the sealed bag to obtain an average weight per bag of oil per unit area of the inside surface 30.

In accordance with another aspect of the present invention, a further method of measuring oil deposited on an inside surface of a bag containing potato chips is provided. The method comprises a first step of providing a first sample of a transparent or translucent flexible material. This first sample is tested to determine the light transmissivity of the first sample. This test is conducted under a predetermined set of illumination and light transmission measuring conditions. This test provides a first baseline transmissivity value of the flexible material. Thereafter, the light transmissivity of a second sample of the same transparent or translucent flexible material is determined. This second sample had previously been used as a bag to package potato chips. The bag has residue oil from the potato chips deposited on one inside surface thereof. The second sample is tested to determine a second transmissivity value of the flexible material coated with the oil. The testing is conducted under the same predetermined set of illumination and light transmission measuring conditions as for the first sample. Finally, the first and second transmissivity values are compared to measure an amount of the oil deposited on the inside of the bag.

This test can readily be used by those skilled in the art to compare the oil deposition of various potato chip products onto a bag surface.

As disclosed hereinabove, the potato chips of the invention can be packaged in a transparent package, such as a bag of flexible film, with minimal oil deposition thereon, which means that the transparent package is acceptable to the consumer because so little oil is deposited on the inside surface of the bag that the oil is visually virtually imperceptible to the consumer when viewing the unopened bag.

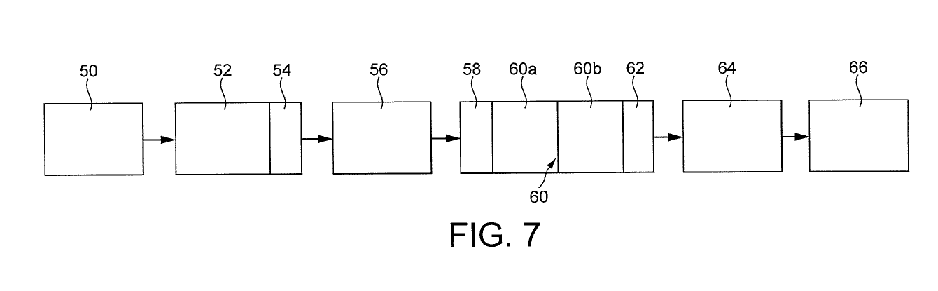

The potato chip of the present invention is manufactured by a process which is schematically illustrated in FIG. 7.

The potato chips are manufactured from potato slices which have a typical thickness of from 1 to 2.5 mm. The potato slices are subjected to a washing step 50 in which the potato slices are washed in water. The potato slices leave the washing step 50 with typically from 7 to 10 wt % free surface water, based on the total weight of the potato slice and the water.

The washed potato slices then proceed to a lipophilic pre-conditioning step 52, in which the potato slices are submerged in oil, in particular vegetable oil such as sunflower oil, in particular high oleic sunflower oil. It is also ensured that the potato slices are individually separated during the lipophilic pre-conditioning step so that the potato slices are uniformly transformed by the pre-conditioning step. The lipophilic pre-conditioning step 52 is carried out under particular conditions. The oil is at an elevated temperature, which is typically 90+/−2° C. and the potato slices are subjected to oil contact for a defined period of time, which is typically 90+/−5 seconds. At the end of the lipophilic pre-conditioning step the potato slices contained in a flow of oil pass down a flume in a separating step 54 which broadens the width of the product flow and delivers individually separated oil coated potato slices onto a conveyor. The oil coated potato slices typically have an oil content of 30 to 45 wt % oil, more typically about 40 wt % oil, based on the dry weight of the final potato chip produced from the potato slice

Thereafter, the oil coated potato slices are subjected to an oil removal step 56. This employs a specific combination of air blades and water jets to reduce the oil content to a value of typically from 10 to 15 wt % oil, more typically about 12.5 wt % oil, based on the dry weight of the final potato chip produced from the potato slice.

The potato slices are then conveyed to a microwave apparatus which carries out a succession of microwave treatment steps on substantially separated potato slices, typically forming a monolayer on a conveyor.

A first microwave step comprises a pre-heating step 58 in which surface moisture is removed and the potato slices are pre-heated under a low power microwave condition. The potato slices entering the microwave step typically have a water content of at least 30 wt %, based on the total weight of the potato slices including the respective water content.

A second microwave step comprises an explosive dehydration step 60 in which the potato slices are rapidly dehydrated under a high power microwave condition. During the explosive dehydration the microwave energy energises water to form steam and the rate of generation of steam is greater than the rate of mass transfer of steam through the product matrix, so that the explosively generated steam ruptures the product matrix, causing texturing of the product surface. Such surface texturing provides organoleptic properties to the final product. The explosive dehydration step 60 is typically carried out as a series of successive sub-steps 60a, 60b in each of which the potato slices are subjected to a respective independent microwave energy field in a respective zone, with microwave attenuation between adjacent zones. The division of the explosive dehydration into plural successive sub-steps in respective independent zones controls the application of microwave energy to the product distribution during the explosive dehydration and provides a more uniform treatment across the distribution.

A third microwave step comprises a moisture levelling step 62 in which the slices are slowly dehydrated under a low power microwave condition in order to reduce the moisture content of the potato slices uniformly across the distribution. The moisture levelling step 62 is carried out by subjecting the potato slices to a respective independent microwave energy field in a respective independent zone. The potato slices leaving the third drying step have a water content of from 10 to 15 wt %, based on the total weight of the product including the respective water content.

A fourth microwave step comprises a drying step 64 in which the potato slices are dried in a further independent microwave drying zone. The drying step 64 has a low power microwave condition in order further to reduce the moisture content of the potato slices uniformly across the distribution to a defined end point. The potato slices entering the drying step 64 typically have a water content of from 10 to 15 wt % and the products leaving the drying step 64 typically have a water content of from 5 to 8 wt %, each weight being based on the total weight of the product including the respective water content.

Subsequently, the potato slices are further dried in a non-microwave drying step, in particular in a convection drying step 66 during which the potato slices are subjected to heated air or other gas such as nitrogen. The potato slices entering the convection drying step 66 typically have a water content of from 5 to 8 wt % and the products leaving the convection drying step 66 typically have a water content of from 1 to 3 wt %, optionally from 1.5 to 2 wt %, each weight being based on the total weight of the product including the respective water content.

Such a final moisture content of the resultant potato chips is uniformly present across the potato chip distribution, so that when the potato chips are packaged, the consumer experiences acceptable product uniformity for the packaged product. The final typical moisture content of from 1 to 3 wt %, optionally from 1.5 to 2 wt %, is a typical moisture content of conventional fried potato chips.

This particular sequence of steps provides a novel potato chip, since the potato chip has an novel oil distribution, particularly with regard to surface oil, and a novel combination of organoleptic properties, being at least partly provided by a microstructure which is light and porous due to the particular pre-treatment and dehydration steps, even without frying, allowing the bulk of the oil to be contained within the chip, away from the surface.

This particular sequence of steps also enhances the product quality and/or product uniformity of snack foods, particularly potato chips produced by a microwave cooking step, such as an explosive dehydration step discussed above, which not only have low oil, and low surface oil in accordance with the invention, but also have the combination of flavour, organoleptic properties and shelf life in a non-fried potato chip which is equal or superior in consumer acceptance to conventional fried potato chips.

The various steps will now be described in greater detail.

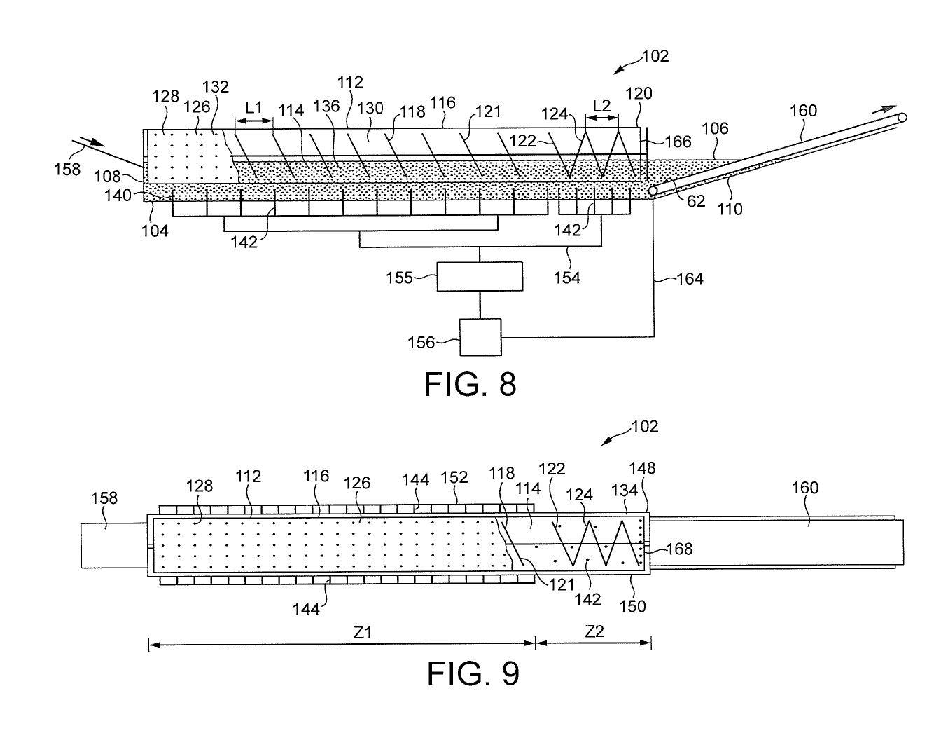

An embodiment of an apparatus for lipophilically pre-conditioning potato slices is illustrated in FIGS. 8 and 9.

Referring to the Figures, an apparatus, designated generally as 102, for lipophilically pre-conditioning potato slices comprises an elongate tank 104 for containing a reservoir 106 of oil. The tank 104 has an upstream end 108 and a downstream end 110. An elongate longitudinal conveyor 112 is disposed in the tank 104, the conveyor 112 being adapted to pass products, in particular potato slices, through the reservoir 106 of oil from the upstream end 108 to the downstream end 110. The conveyor 112 defines therealong a plurality of compartments 114 for containing respective groups of products during passage from the upstream end 108 to the downstream end 110.

The conveyor 112 comprises a rotatable cylindrical drum 116 having a helical auger 118 mounted therein. The rotational axis of the drum 116 is typically slightly above the upper level of the oil reservoir 106. The drum 116 and the helical auger 118 are rotated continuously by a drive motor (not shown). In other embodiments of the invention, as an alternative conveyor to the use of an auger, other conveying mechanisms could be employed, such as a conveyor incorporating pockets or a paddle blancher, both known to those skilled in the art.

A downstream end 120 of the helical auger 118 has a combination of first and second superposed helical elements 122, 124 of opposite rotational direction, each compartment 114 at the downstream end 120 being defined between respective first and second helical elements 122, 124.

The longitudinal wall 126 of the drum 116 has a plurality of perforated holes 128 to permit oil to flow into and out of a central cavity 130 of the drum 116. The perforated holes 128 are regularly spaced along and around the drum 116. For at least an upstream portion 132 of the drum 116 the perforated holes 128 have a total surface area of from 25 to 60% of the area, optionally about 40% of the area, of the longitudinal wall 126 of the drum 116. For at least a downstream portion 134 of the drum 116 the perforated holes 128 have a total surface area of from 10 to 40% of the area, optionally about 25%, of the longitudinal wall 26 of the drum 116, which total surface area is lower than for the upstream portion 132 of the drum 116. The downstream portion 134 of the drum 116 has a length substantially corresponding to a length of a final compartment 114 of the conveyor 112. Typically, the perforated holes 128 have a width of from 2 to 10 mm, optionally 4 to 8 mm, further optionally about 6 mm.

A first group 136 of compartments 114 located towards the upstream end 108 has a first length L1 and a second group 138 of compartments 114 located towards the downstream end 110 has a second length L2, the first length L1 being longer than the second length L2. Typically, there are from ten to twenty compartments 114 in the first group 136, optionally fourteen compartments 114, and from two to five compartments 114, optionally three compartments 114, in the second group 138. Typically, the compartments 114 of first group 136 have a compartment length of from 150 to 400 mm, optionally 200 to 250 mm, further optionally about 230 mm. As mentioned above, the compartments 114 of the second group 138 are formed from two rotationally opposite helical screw elements 122, 124, having a compartment length of from 100 to 300 mm, optionally 125 to 175 mm, further optionally about 150 mm. The provision of helically opposite screw elements 122, 124 at the discharge end of the auger 118 provides a more even product flow, because there is a greater number of compartments 114 for any given conveyor length and because the product output is directed by the helical surfaces partly towards alternating lateral sides of the end of the auger 118.

At least one oil jet 140 is located on the tank 104 for causing turbulent flow in the reservoir 106 of oil. An oil circulation system 149 communicates between the tank 104 and the at least one oil jet 140 to provide oil to the at least one oil jet 410 from a bottom portion of the tank 104.

In the embodiment, a plurality of the oil jets 140 are located along at least a majority of the length of the tank 104. A first group 142 of oil jets 140 is located on a bottom 144 of the tank 104 and direct oil upwardly towards the drum 116 and a second group 146 of oil jets 140 is located on at least one side 148, 150 of the tank 104 and direct oil laterally towards the drum 116. Typically, the first group 142 of oil jets 140 are oriented perpendicular to the drum rotation and direct turbulent oil vertically upwardly.

The tank 104 comprises at least two zones, Z1, Z2 successively located therealong, each zone Z1, Z2 having a respective jet configuration.

A first zone Z1 extends along a major portion of the tank 104 and comprises upwardly directed oil jets 142 and laterally directed oil jets 144. In the first zone Z1 the upwardly directed oil jets 142 are mutually spaced along the length of the tank 104, for example by a distance of from 75 to 250 mm, optionally 125 to 175 mm, further optionally about 150 mm, to provide a continuous agitation of oil along the length of the first zone Z1. In the first zone Z1 the upwardly directed oil jets 142 may additionally be mutually spaced across the width of the bottom of the tank 104 to provide a continuous agitation of oil across the width of the first zone Z1. In the first zone Z1 the upwardly directed oil jets 142 are connected to an oil supply system 154 adapted to pump oil out of the upwardly directed oil jets 142. In the first zone Z1 the upwardly directed oil jets 142 are adapted to direct oil into the tank 104 at a common velocity, optionally the velocity being from 5 to 15 metres/second. The upwardly directed oil jets 142 typically have a nozzle diameter of about 7.5 mm.

In the first zone Z1 the laterally directed oil jets 144 are mutually spaced along the length of the tank 104 on opposite sides 148, 150 of the tank 104. In the first zone Z1 the laterally directed oil jets 144 are mutually spaced along the length by a distance of from 20 to 50 mm, optionally 25 to 45 mm, and are spaced from the conveyor 112 by a distance of from 10 to 50 mm, optionally 20 to 30 mm, further optionally about 25 mm. In the first zone Z1 the laterally directed oil jets 144 are connected to an oil supply system 152 adapted to pump oil out of the laterally directed oil jets 144 at an exit velocity of from 5 to 20 metres/second, optionally from 10 to 15 metres/second. The laterally directed jets 144 typically have a nozzle diameter of about 3 mm.

The oil supply systems 152, 154 include at least one pump 156 for providing pressurised oil to the oil jets 142, 144 and a heater 155 for heating the oil to the desired lipophilic treatment temperature. The oil pressure is typically from 1×10⁻³ to 10×10⁻³ N/m², optionally about 5×10⁻³ N/m² (about 35 psi). The oil temperature is typically maintained at 90° C.+/−2° C. If desired, oil clean-up may be provided by, for example, a water recovery device and/or a filter.

In the second zone Z2 the upwardly directed oil jets 142 are formed as plural lines of oil jets 142, the lines being mutually spaced in a direction across the width of the tank 104 and the oil jets 142 of each line being mutually spaced in a direction along the length of the tank 104. Typically, in the second zone Z2 the upwardly directed oil jets 142 are mutually spaced along the length by a distance of from 75 to 250 mm, optionally 125 to 175 mm, further optionally about 150 mm, and mutually spaced across the width of the bottom of the tank 104 by a distance of from 25 to 150 mm, optionally 50 to 100 mm, further optionally about 75 mm.

In the second zone Z2 at least some of the upwardly directed oil jets 142 are located at a downstream end of the conveyor 104.

A weir 158 is located at the upstream end 108 of the tank 104 for inputting products, such as potato slices, in a flow of oil into the tank 104. The oil flow in the weir 158 is selected so as to be sufficient to prevent slices from sticking to walls and other surfaces of the weir 158.

An output belt conveyor 160, comprising an oil-permeable belt, for example of metal mesh, is located at the downstream end 110 of the tank 104 for outputting oil-conditioned products, such as potato slices, from the tank 104. The upstream end 162 of the output belt conveyor 160 is submerged within the reservoir 106 of oil. The downstream end 120 of the rotating helical auger 118 urges products from the end compartment 114 at the downstream end 120 onto the output belt conveyor 160. The output belt conveyor 160 is inclined upwardly out of the tank 104. As the products exit the reservoir 106 of oil, excess oil can drip back down into the tank or an adjacent oil recovery device 164 through the oil-permeable belt. The output belt conveyor 160 delivers the oil-conditioned products to a subsequent processing apparatus, in particular a flume, as described hereinafter.

The circulating oil flow includes three controllable circuits. These circuits are controllable via a control valve, such as a manual notch ball valve or a gate valve.

A first circuit includes the bottom jets 142 along the majority of the length of the drum 116, which are coupled to a control valve, and the side jets 144 along the majority of the length of the drum 116, which are not coupled to a control valve so the side jets 144 are always fully open. The bottom and side jets 142, 144 introduce turbulent flow of the oil which keeps the slices in motion and separated while they travel through the drum 116. The oil flow from the side jets 144 also serves to remove slices that may be stuck on the inside of the rotating drum 116. The side jets 144 are evenly spaced along the majority of the length of the drum and are located below the oil level in the tank 104. The side jets 142 have an exit velocity and are oriented so that the exiting turbulent oil does not break the oil surface in the tank 104 and thereby increase air entrainment.

A second circuit is at the discharge downstream end 120 of the helical auger 118. There are three longitudinally oriented rows of bottom jets 142 pointing upwardly towards the drum 116, and at least some of these bottom jets 142 are inclined forwardly at an angle to the vertical, so as to assist directing the endmost slices onto the output belt conveyor 160. These rows are staggered to provide an array of closely spaced jets 142 to spread the agitation along the transverse width of this final section prior to exiting the drum 116. The closely spaced jets 142 are typically spaced 75 mm (3 inches) apart width-wise and 150 mm (6 inches) apart length-wise. There is also a single row of transversely oriented bottom jets 142 pointed along a back plate 166 of the drum 116 to keep the turbulent oil flow energized on the back plate 166, with these bottom jets being optionally inclined forwardly at an acute angle to the vertical so as to be oriented towards the back plate 166. These two flows have separate valve adjustment. The slices are agitated by the turbulent oil and forced by the oil flow forwardly out of the drum 116 and onto the output belt conveyor 160.

A third circuit comprises the oil flow over the weir 158. All or part of this flow may be independently captured and re-circulated.

In the method of lipophilically pre-conditioning potato slices, according to the embodiment of the present invention, the potato slices are conveyed through the reservoir 106 of oil contained in the tank 104. The potato slices are conveyed using the rotating helical auger 118 which constitutes an elongate conveyor defining therealong a plurality of compartments 114 for containing respective groups of potato slices. Oil is injected into the reservoir 106 from the at least one oil jet 142, 144 located on the tank 104. The injected oil causes turbulent flow in the reservoir 106 of oil and agitation of the potato slices in the oil.

The potato slices 106 typically have a thickness of 1 to 2.5 mm, more typically about 1.3 mm (51 thousandths of an inch). The input potato slices are typically washed potato slices, with 7 to 10 wt % free surface water. The rotating helical auger 118 is able to convey single slices even though there may be a degree of overlap of slices or clumping in the product input. This is because the slices are dropped into the oil at the upstream end and then singulate, i.e. the clumps and overlaps are removed by separation of the slices into single slices, under the agitating action of the turbulent oil and by movement of the auger.

The provision of controlled plug flow of the products through the reservoir 106 of oil by provision of the constant velocity translating compartments 114 provides that the residence time of each slice in the reservoir 106 of oil is highly uniform. Each slice is resident in the oil for a predetermined period, typically 90 seconds. The compartmental conveyor mechanism ensures that the slices have a total residence time of 90 seconds with a tolerance of +/−5 seconds. This control of temperature and residence time, in combination with the slice separation and agitation provides that each slice is exposed equally to the lipophilic pre-conditioning process. The slices remain submerged in the oil between the upstream end 108 and downstream end 110 of the tank 104. The oil circulation system 149 and the associated jets 142, 144 act in conjunction with rotating helical auger 118 to agitate the slices in the oil.

The slices are fully contained in the compartments throughout the lipophilic pre-conditioning process, resulting in a well-defined lipophilic pre-conditioning residence time with minimal damage to, or loss of, slices. Turbulence is used inside the lipophilic pre-conditioning apparatus to separate the slices, allowing for sufficient enzyme deactivation and slice separation at the downstream output end.

The potato slices are pre-treated in oil in the lipophilic preconditioning process and thereafter have about 30 wt % surface oil, based on the dry weight of the final potato chip produced from the potato slice. In this specification the “dry weight of the final potato chip” assumes 2 wt % water content in the total weight of the final cooked and dried potato chip, prior to final seasoning of the potato chip. The potato slices are then conveyed to a flume apparatus.

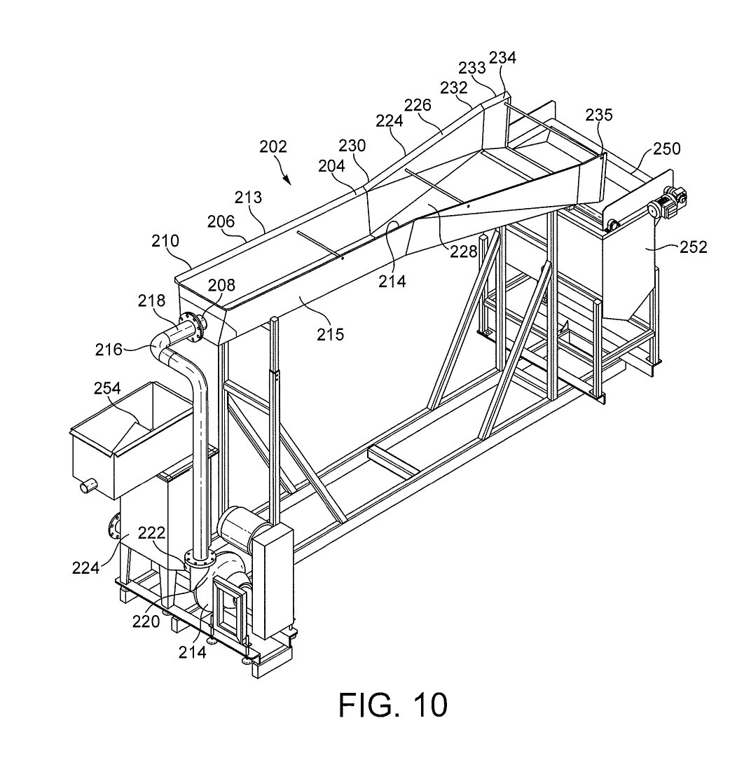

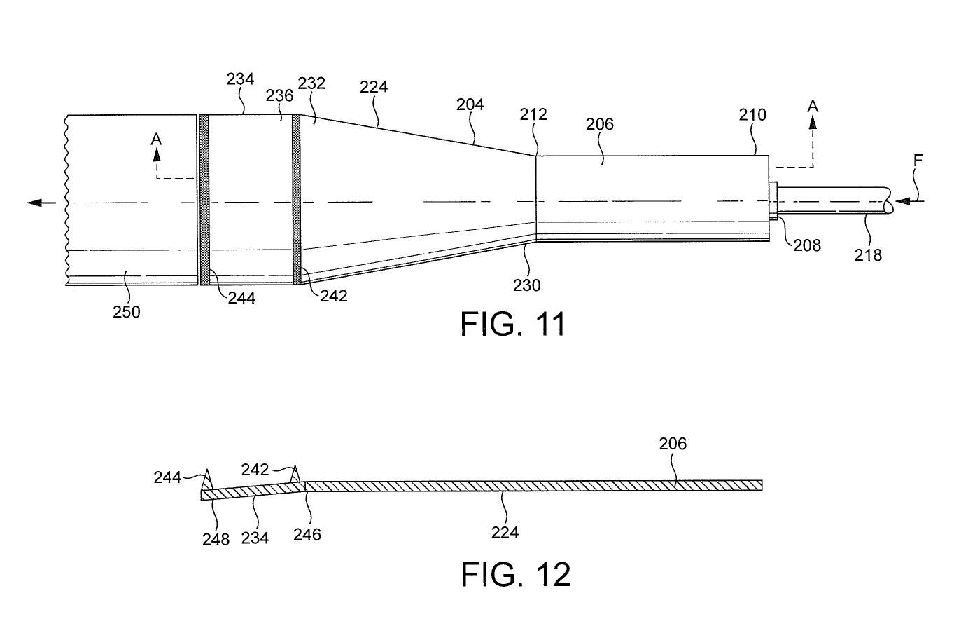

An embodiment of a flume apparatus for separating potato slices in oil according to one aspect of the present invention is illustrated in FIGS. 10 to 12.

Referring to FIGS. 10 to 12, an apparatus, designated generally as 202, for separating potato slices in a supply of oil, comprises a flume 204. The oil temperature is at an elevated temperature, for example coming from the preceding lipophilic pre-conditioning step at a temperature of 90° C.+/−2° C.

The flume 204 comprises a gulley 206 having a flume inlet 208 at an upstream inlet end 210 and a downstream outlet end 212, and having opposed lateral walls 213, 215. The gulley 206 is rectangular, has a major length in the flow direction F and a constant width, for example 300 mm. A pump 214 is connected by an outlet pipe 216 to the gulley 206 for pumping a supply of oil containing a plurality of potato slices into the gulley 206, with a horizontal inflow pipe 218 connected to the upstream inlet end 210. An inlet 220 of the pump 214 is connected by an inlet pipe 222 to a tank 224 for holding the supply of oil containing the plurality of potato slices. The tank 224 is fed from a weir 254 of a tank which is on the downstream end of the lipophilic pre-conditioning unit.

The gulley 206 is downwardly inclined in the flow direction F at an angle to the horizontal of from 0.5 to 5 degrees, optionally 1 to 3 degrees, further optionally about 2 degrees. The inflow pipe 218 supplies a constant flow of oil containing potato slices into the gulley 206, and a corresponding constant flow of oil containing potato slices exits the gulley 206. The oil flow velocity through the flume 4 is up to 10 m/s, optionally from 0.6 to 5 m/s, typically 1.5 to 2 m/s. Such a velocity provides singulation of slices in the flume 4. The weight ratio of the potato slices to the oil in the flow through the flume 4 is from 0.5 to 3 wt %.

A fishtail ramp 224 having opposed lateral walls 226, 228 is connected at an upstream end 230 thereof to the downstream end 212 of the gulley 206. The fishtail ramp 224 progressively increases in width from the upstream end 230 to a downstream end 232 by the lateral walls 226, 228 both diverging at a constant angle relative to the flow direction along of the fishtail ramp 224. Typically, the constant angle is from 5 to 30 degrees, optionally 10 to 20 degrees, further optionally about 15 degrees. Typically, the downstream end 232 of the fishtail ramp 224 is increased in width by a factor of from 2 to 5, optionally by a factor of from 3 to 4, compared to the upstream end 30 of the fishtail ramp 24. The fishtail ramp 224 is downwardly inclined in the flow direction at an angle to the horizontal typically of from 0.5 to 5 degrees, optionally 1 to 3 degrees, further optionally about 2 degrees.

A discharge chute 234, having opposed lateral walls 233, 235 is connected at an upstream end 236 thereof to the fishtail ramp 224. The discharge chute 234 has a constant width which is the same as that of the downstream end 232 of the fishtail ramp 224. The discharge chute 234 is downwardly inclined in the flow direction at an angle to the horizontal greater than the angle to the horizontal of the fishtail ramp 224, typically from 3 to 10 degrees, optionally 4 to 8 degrees, further optionally about 5 degrees. The discharge chute 234 typically has a length of from 100 to 400 mm, optionally about 200 mm.

At least one transversely extending ridge 242, 244 is mounted on an upper surface of the discharge chute 234. Alternatively, the ridges 242, 244 may be integral with the discharge chute 234. The ridges 242, 244 comprise a first ridge 242 at a junction 246 between the fishtail ramp 224 and the discharge chute 234 and a second ridge 244 at an end portion 248, in the flow direction, of the discharge chute 234. The ridges 242, 244 are typically separated by a distance of from 150 to 250 mm, optionally from 170 to 180 mm, in the flow direction. The ridges 242, 244 have a triangular cross-section, and typically a height of from 10 to 30 mm, optionally about 20 mm. The ridges 242, 244 act to slow down the flow of oil containing the potato slices as the flow exits the fishtail ramp 224.

The discharge chute 234 exits onto an output conveyor 250, typically an endless belt conveyor, which is located below the discharge chute 234 and may be oriented along or at an angle to, even perpendicular to, the flow direction. The output conveyor 250 may be horizontal or inclined at a small angle, such as up to 10 degrees, to the horizontal. The output conveyor 250 typically has a translational velocity of from 0.1 to 0.8 m/s, optionally 0.2 to 0.5 m/s.

The output conveyor 250 is mounted above an oil recovery tank 252. The output conveyor 250 is oil permeable, for example comprising an endless belt composed of metal mesh, such as stainless steel mesh. The oil can drip through the mesh into the recovery tank 252 for subsequent re-use, optionally after clean up such as water removal and/or filtering.

In the method of separating potato slices in a supply of oil, the supply of oil containing potato slices is fed into the gulley 206 from the pump 214 via the outlet pipe 216. The pump 214 is supplied from the tank 224 holding the supply of oil containing the potato slices, and fed from the weir 254.

The potato slices in the oil flow from the downstream end 214 of the gulley 206 and down the fishtail ramp 224. Since the fishtail ramp 224 progressively increases in width from the upstream end 230 to the downstream end 232, the downwardly flowing potato slices progressively and uniformly spread width wise across the width of the fishtail ramp 224. The potato slices in the oil are discharged onto the output conveyor 252 from the discharge chute 234.

The provision of a constant width for the gulley 206 along the length thereof provides a substantially uniform flow of potato slices. The distribution of potato slices within the oil is made more uniform by pumping into the gulley a high velocity supply of oil containing the potato slices. This means that the potato slices are flowed into the gulley 206 in a distribution of substantially individual single slices. Such uniform slice singulation is assisted by the shallow downward inclination of the gulley 206 at an angle to the horizontal.

The progressive symmetric increase in the width of the fishtail ramp 224, coupled with the shallow downward inclination of the gulley 206 at an angle to the horizontal, broadens the width of the output flow as compared to the input flow, and maintains uniform slice separation as the flow broadens. The downstream end 232 of the fishtail ramp 224 is increased in width by a factor of from 2 to 5, optionally by a factor of from 3 to 4, compared to the upstream end 230 of the fishtail ramp 224 correspondingly to spread the potato slices across the width of the fishtail ramp 224 as the potato slices flow down the fishtail ramp 224.

The discharge chute 234 is downwardly inclined at an angle to the horizontal greater than the angle to the horizontal of the fishtail ramp 224. The transversely extending ridges 242, 244 slow down, i.e. decelerate the flow of oil and potato slices down the discharge chute. This combination of features provides that the potato slices are separately and independently distributed on the conveyor 250, and tend not to skid significantly when deposited onto the translating conveyor 250. This correspondingly reduces the incidence of touching potato slices on the conveyor 250. This provides that the potato slices can be distributed on the conveyor 250 with at least 70% of the slices being non-overlapping single slices, no more than 10% of the single slices touching another single slice, and at least 15% coverage of the area of the conveyor 250 by the potato slices.

The oil drips off the potato slices disposed on the conveyor 250 and passes through the oil-permeable belt into the tank 252, thereby capturing the oil for re-use.

Each slice is resident in the oil for a substantially common predetermined period, because of the substantially uniform slice flow from the gulley 206 to the conveyor 250.

The flume 206 provides that the slices have a well-defined lipophilic pre-conditioning total residence time in the oil with minimal damage to, or loss of, slices.

After the lipophilic preconditioning process following deposition of the slices onto the conveyor 250, excess oil is removed in a de-oiling step, as described hereinafter.

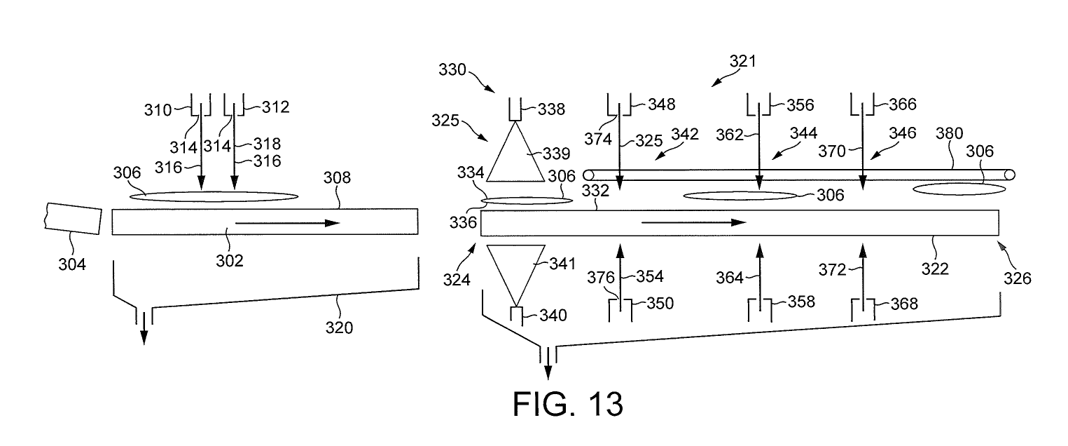

An embodiment of an apparatus for de-oiling potato slices according to one aspect of the present invention is illustrated in FIG. 13.

A primary endless belt conveyor 302 having a substantially horizontal orientation is provided. An inlet end of the conveyor 302 communicates with an exit of an oil flume 304 (illustrated schematically) of the lipophilic preconditioning unit for the potato slices 306. The conveyor 302 carries a succession of the potato slices 306 on its upper surface 308. The potato slices 306 have been randomly delivered onto the conveyor 302. The potato slices 306 are delivered onto the conveyor 302 in a slice distribution so as to have at least about 50% of the slices being single slices, i.e. not overlapping with an adjacent slice. In addition, at least 50% of the overlaps are no more than 50% of the area of each of the respective overlapping slices. Also, for each overlap no more than two slices 306 are stacked one upon the other on the conveyor 302. This substantially provides a monolayer of potato slices 306 across the length and width of the conveyor 302.

The potato slices 306 have been pre-treated in oil in the lipophilic preconditioning process and initially, prior to the de-oiling step, have about 30 to 45 wt % surface oil, typically about 40 wt % surface oil based on the dry weight of the final potato chip produced from the potato slice 306.

The conveyor 302 has a translational speed of from 0.1 to 0.5 m/second, typically about 0.2 m/second. As the potato slices 306 are carried on the upper surface of the primary conveyor 302, air is blown downwardly onto the potato slices 306 in a continuous manner at a primary air-blower station 318. The velocity of the air is typically from 30 to 60 metres per second, more typically from 40 to 50 metres per second, optionally from 45 to 50 metres per second. The primary air-blower station 318 comprises a set of a plurality of primary air knives 310, 312 which are mounted above the primary conveyor 302. In the embodiment, two longitudinally spaced air knives 310, 312 are provided. Each of the air knives 310, 312 typically has an air exit aperture 314 extending along the length of the air knife 310, 312, which extends transversely across the conveyor 302, for generating a downwardly-directed air blade 316 extending across the width of the conveyor 302. The air exit aperture 314 may have a width of from 0.5 to 1.5 mm, optionally 0.75 to 1.25 mm, further optionally about 1 mm. Each air knife 310, 312 is located so that a distance from the air exit aperture 14 to the upper surface 308 of the conveyor 302 carrying the potato slices 306 is from 20 to 40 mm, optionally 25 to 35 mm, further optionally about 30 mm.

The air knives 310, 312 generate downwardly directed parallel air blades 316, spaced in the direction of movement of the potato slices 306 along the conveyor 302, and act to blow excess surface oil on the potato slices 306 back into an oil supply for the lipophilic preconditioning apparatus. The air blades 316 most typically have an air velocity of 48 m/second.

For example, the excess oil removed by the air blades 316 is blown downwardly through the conveyor 302, and is captured by an oil capture device 320 located thereunder. The conveyor 302 is permeable to the oil and typically comprises an open mesh structure, for example comprised of a stainless steel balanced spiral wire mesh belt.

The air knives 310, 312 are parallel and longitudinally separated by a distance of, for example, a distance of from 100 to 300 mm, typically about 150 mm, so that each potato slice 306 is sequentially impacted by plural air blades 316 during the passage of the potato slice 306 through the primary air-blower station 318. Alternatively, the air knives 310, 312 may be separated by a distance which is less than a typical dimension of a potato chip, for example a distance of less than 50 mm, such as 30 to 40 mm, so that each potato slice 306 is simultaneously impacted by plural air blades 316 during at least a portion of the passage of the potato slice 306 through the primary air-blower station 318. Optionally, the air knives 310, 312 are inclined rearwardly so that the displaced oil is directed rearwardly into the oil capture device 320, which enhances oil capture.

After this preliminary step of blowing off excess surface oil with air blades, the conveyor 302 feeds the potato slices 306 to a de-oiler unit 321. The de-oiler unit 321 includes a second de-oiler belt conveyor 322 which, similar to conveyor 302, is an endless belt mounted substantially horizontally and has a belt speed of from 0.1 to 0.5 m/second, typically about 0.2 m/second. The conveyor 322 is also permeable to oil and water, and comprises a similar open mesh structure as conveyor 302, for example a stainless steel balanced spiral wire mesh belt. The de-oiler conveyor 322 conveys the potato slices 306 from an upstream end 324 to a downstream end 326 through a succession of de-oiling stations.

A first de-oiling station 328, located relatively upstream along the conveyor 322, comprises a water spray station 330 which sprays water onto the potato slices 306 which are carried on the upper surface 332 of the conveyor 322. The water is sprayed both downwardly from an upper water spray device 338, forming an upper spray 339, and upwardly from a lower water spray device 340, forming a lower spray 341. Typically, in each water-spray device 338, 340 a plurality of water pressure nozzles is provided across the width of the conveyor 322. Typically, the water exits of the water spray devices 338, 340 are located a distance of from 50 to 150 mm, optionally 75 to 125 mm, further optionally about 100 mm, from the conveyor upper surface 332 carrying the potato slices 306.

At the water spray station 330, water is sprayed onto both upper and lower major surfaces 334, 336 of each of the potato slices 306. The water spray impacts on the upper and lower surfaces 334, 336 of the potato slices 306 and acts to displace and lift surface oil from the surfaces of the slice 306.

A typical water feed rate from each of the upper and lower water devices 338, 340 is from 3 to 5 kilograms of water per minute, optionally from 4 to 4.5 litres of water per minute, most typically 4.2 litres/minute, for a typical potato slice throughput of 250 kilograms per hour, i.e. from 0.72 to 1.2 litres of water per hour per kg of potato slices per hour, optionally from 0.96 to 1.08 litres of water per hour per kg of potato slices per hour.

After this initial surface oil lifting step using water, a succession of pairs of oppositely directed secondary air knives, and directed towards each other, is employed to remove the lifted oil, mixed together with the residual water, from the surfaces 334. 336 of the potato slices 306. In the embodiment, three successive sets 342, 344, 346 of upper and lower air knives are employed, which sets 342, 344, 346 are located in a mutually spaced configuration extending along a portion of the length of the conveyor 322 downstream of the water spray station 330.

Accordingly, there are plural parallel sets 342, 344, 346 of upper and lower secondary air knives mounted above and below the conveyor 322 which are adapted to provide high velocity air, as a narrow blade-like flow extending across the width of the conveyor 322, with the high velocity air blade blowing the water and oil mixture from the surfaces 334, 336 of the potato slices 306. The velocity of the air is typically from 30 to 60 metres per second. The water and oil mixture which has been blown off the slices falls downwardly into a base 360 of the de-oiler unit for removal and reuse or recycling. The air blades produced from the sets 342, 344, 346 of upper and lower air knives are parallel.

A first air knife set 342 comprises upper and lower air knives 348, 350 each of which is arranged to blow an air blade 352, 354 at a high velocity onto the upper or lower surface 334, 336, respectively, of the potato slices 306 on the conveyor 306. For these air knives 348, 350 the air velocity may be from 30 to 40 metres per second, optionally from 32 to 37 metres per second. Typically, the upper air knife 348 has an air blade velocity of 34 m/second and the lower air knife 350 has an air blade velocity of 35 m/second.

A second air knife set 344 comprises upper and lower air knives 356, 358 each of which is arranged to blow an air blade 362, 364 at a high velocity onto the upper or lower surface 334, 336, respectively, of the potato slices 306. For these air knives 356, 358 the air velocity may be from 40 to 50 metres per second, optionally from 45 to 50 metres per second. Typically, the upper air knife 356 has an air blade velocity of 47 m/second and the lower air knife 358 has an air blade velocity of 47 m/second.

A third air knife set 346 comprises upper and lower air knives 366, 368 each of which is arranged to blow an air blade 370, 372 at a high velocity onto the upper or lower surface 334, 336, respectively, of the potato slices 306. For these air knives 366, 368 the air velocity may be from 40 to 50 metres per second, optionally from 45 to 50 metres per second. Typically, the upper air knife 366 has an air blade velocity of 46 m/second and the lower air knife 368 has a velocity of 47 m/second.

The use of a plurality of sequential successive pairs of oppositely directed air knives mounted both above and below the conveyor 322 in the de-oiler unit provides a greater degree of control in achieving a desired weight % of oil in the de-oiled potato slices 306 leaving the de-oiler unit 321.

For each of the air knife sets 342, 344, 346, a typical distance from the respective upper or lower air knife exit aperture 374, 376 to the upper surface 332 of the conveyor 322 carrying the potato slices 306 is from 20 to 40 mm, optionally 25 to 35 mm, further optionally about 30 mm. Each of the air knives 348, 350, 356, 358, 366, 368 has an exit aperture 374, 376 extending along the length of the air knife 348, 350, 356, 358, 366, 368, which exit aperture 374, 376 extends transversely across the conveyor 322, for generating an air blade 352, 354, 362, 364, 370, 372 extending across the width of the conveyor 322. The air exit apertures 374, 376 may have a width of from 0.5 to 1.5 mm, optionally 0.75 to 1.25 mm, further optionally about 1 mm.

Since the air knife sets 342, 344, 346 blow air upwardly as well as downwardly, in order to avoid the potato slices 306 being blown off the conveyor 322 a longitudinally oriented hold-down belt 380 is located above the conveyor 322 in the vicinity of the air knife sets 342, 344, 346. The potato slices 306 are conveyed between the lower conveyor 322 and the upper hold-down belt 380 and are held in position as they are conveyed successively past the air knife sets 342, 344, 346. The hold-down belt 380 is typically undriven, but it may alternatively be driven so as to assist the conveyor 322.

In the illustrated embodiment, there are three sets of air knives 342, 344, 346 downstream of the water spray station 330. In other embodiments a larger number of air knife pairs is provided, which can provide enhanced uniformity of oil content of the de-oiled potato slices. In contrast, since the air knives 310, 312 blow air only downwardly, a hold-down belt is not required. The potato slices 306 are agitated by the downwardly blown air from the air knives 310, 312, which agitation assists removal of free surface oil, but the slices remain on the conveyor 302.

The final oil percent amount in the de-oiled potato slices 306 is achieved by balancing the amount of water and the amount of air supplied. It is possible to use more air and less water and vice versa to fine tune the de-oiling operation and the final oil content. The target final oil content for the potato slices using the de-oiler is 12.5 wt % oil+/−2 wt % based on the dry weight, having 2 wt % water content, of the final cooked and dried potato chip after microwave explosive dehydration and final drying.

After the de-oiling step, the potato slices are subjected to microwave dehydration.

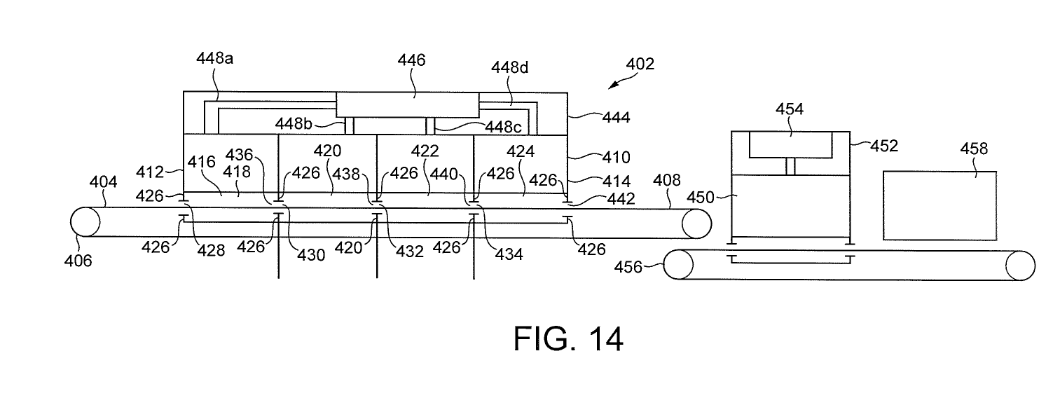

An embodiment of a dehydration apparatus including a microwave apparatus according to one aspect of the present invention is illustrated in FIG. 14. A conveyor is employed to feed potato slices to a microwave apparatus for cooking and explosively dehydrating the potato slices in order to produce potato chips, which have not been fried, as for a conventional potato chip.

In particular, an apparatus, designated generally as 402, for the manufacture of snack foods, such as potato chips from potato slices, comprises a first conveyor 404, such as an endless belt conveyor, having an upstream end 406 and a downstream end 408. The conveyor 404 may have a substantially horizontal orientation or may be slightly inclined to the horizontal. A flat bed microwave apparatus 410 for cooking products conveyed through the microwave apparatus 410 by the conveyor 404 has an upstream end 412 and a downstream end 414. The opposed upstream and downstream ends 412, 414 define at least one elongate cavity 416 therebetween. The conveyor 404 extends through the at least one elongate cavity 416.

The microwave apparatus 410 is configured to define a plurality of successive independent microwave zones 418, 420, 422, 424 between the upstream and downstream ends 412, 414 of the microwave apparatus 410. Each zone 418, 420, 422, 424 has a respective microwave attenuator 426 at an upstream inlet 428, 430, 432, 434 and at a downstream outlet 436, 438, 440, 442. The microwave attenuator 426 may comprise an array of choke pins or a tunnel, both of which are known per se to those skilled in the art.

The microwave zones 418, 420, 422, 424 comprise a first preheating zone 418 located towards the upstream end 412 of the microwave apparatus 410. At least one second explosive dehydration zone 420, 422 is located downstream of the first preheating zone 418. A third moisture levelling zone 424 is located downstream of the at least one second explosive dehydration zone 420, 422.

The first zone 418, second zones 420, 422 and third zone 424 are assembled in a common housing 444 together with a common microwave generator 446, with waveguides 448a, 448b, 448c, 448d adapted to transmit respective proportions of the microwave energy from the common microwave generator 446 to the respective first, second and third zones 418, 420, 422, 424.

In an alternative embodiment, not illustrated, the first, second and third zones 418, 420, 422, 424 are defined by respective housings, each housing having a respective microwave generator.

A fourth microwave drying zone 450 is located downstream of the third zone 424. The fourth zone 450 is defined by a second flat bed microwave apparatus 452, having a respective microwave generator 454.

A second conveyor 456, such as an endless belt conveyor, is provided for conveying products through the fourth zone 450. The second conveyor 456 may have a substantially horizontal orientation or may be slightly inclined to the horizontal. The first conveyor 404 is arranged to deposit products on the second conveyor 456. The second conveyor 456 is adapted to convey products at a higher mass flow rate, and optionally at a deeper bed depth, than the first conveyor 404.

The conveyor 404 through the microwave apparatus 410 has a speed control adapted, together with the length of the first, second and third zones 418, 420, 422, 424, to convey products thereon through the first, second and third zones 418, 420, 422, 424 in a total period of from 40 to 100 seconds, optionally from 70 to 90 seconds, further optionally about 80 seconds. The second conveyor 456 has a speed control adapted, together with the length of the fourth zone 450, to convey products thereon through the fourth zone 450 in a period of from 90 to 180 seconds, optionally from 100 to 150 seconds, further optionally about 120 seconds.

A convector drying apparatus 458 is provided for drying the conveyed products downstream of the fourth zone 450. The second conveyor 456 conveys products through the convector drying apparatus 458, which dries the products further using heated air or other gas such as nitrogen.

The microwave apparatus 410 is adapted respectively to provide first, second and third microwave power values to the respective first, second and third zones 418, 420, 422, 424.

Preferably, there are plural, for example two, successive second explosive dehydration zones. In each of the second zones 420, 422 the second microwave power value is preferably from 1.25 to 5 times, optionally from 1.5 to 4 times, further optionally from 1.5 to 2.5 times, higher than the first microwave power value. In all of the second zones 420, 422 the total second microwave power value is preferably from 2 to 8 times, optionally from 2.5 to 6 times, further optionally from 3 to 5 times, higher than the first microwave power value.

The second microwave power value is higher than the third microwave power value. Preferably, the second microwave power value is from 1.1 to 2 times, optionally from 1.25 to 1.75 times, further optionally about 1.5 times, higher than the third microwave power value.

The third microwave power value is higher than the first microwave power value. Preferably, the third microwave power value is from 1.5 to 2.5 times, optionally from 1.75 to 2.25 times, further optionally about 2 times, higher than the first microwave power value.

The fourth drying zone 450 has a fourth microwave power value which is lower than the first microwave power value. The first microwave power value is from 1.25 to 2.5 times, optionally from 1.5 to 2.25 times, further optionally from 1.5 to 1.75 times, higher than the fourth microwave power value.

In the method for the manufacture of snack foods, such as potato chips from potato slices, the plurality of products, such as potato slices, to form snack food products, such as potato chips, is conveyed through the flat bed microwave apparatus 410. The products are preheated in the first preheating zone 418, then explosively dehydrated in the at least one second explosive dehydration zone 420, 422, the products being explosively dehydrated at a first drying rate, and then dried in the third drying zone 424.

The potato slices have been randomly delivered onto the conveyor 404 but with a product flow along and across the conveyor 404 so as to provide a substantially constant product flow, but with less than 100% uniformity and some slice overlap. The potato slices are typically delivered onto the conveyor 404 in a slice distribution so as to have no more than about 50% of the slices overlapping with an adjacent slice, with any such overlap to be no more than about 50% of the slice dimension, and with no more than two slices being stacked one upon the other on the conveyor 404. This substantially provides a monolayer of potato slices across the length and width of the conveyor 404, but with some overlapping and consequential variation of microwave load along and across the conveyor 404.

Since the potato slices are thin and flexible, they are readily able to overlap each other. This means that the flow rate of the potato slices along the manufacturing line, and in particular through specific apparatus in the manufacturing line, such as the microwave apparatus 410, can vary over a short period of time, for example less than one minute, with potential deterioration in product quality and/or uniformity.

That is why the microwave apparatus 410 is divided into a series of independent zones. The zones divide the dehydration and explosive dehydration of the products into specific independent and successive operations, with the input microwave power being controlled so as to cause, in each respective zone, the desired surface or bulk dehydration at the desired rate. By control of these various drying rates, the moisture content of the final products can be very uniform, for example a moisture content at a values selected within the range of 1.5 to 2 wt % water based on the weight of the final snack food product prior to seasoning, with a very high product uniformity, for example the moisture content varying within a batch by as little as +/−0.1 wt % water.

Such moisture control is accompanied by texture control, resulting in products which have a very uniform texture, and accordingly uniform organoleptic properties to the consumer.

The explosive dehydration causes texture to be developed in the product. Since the products entering the second explosive dehydration zones have a uniform moisture profile, with regard to surface moisture and bulk moisture, the explosive dehydration causes a more uniform bulk dehydration, and more uniform texture. Such uniformity is enhanced by providing plural second explosive dehydration zones, so that the microwave energy is evenly distributed during the explosive dehydration.

The microwave preheating/surface drying step has not been preceded by any air heating step. The microwave preheating/surface drying step is carried out on wet products, such as potato slices which have been subjected to a lipophilic pre-conditioning step in oil followed by a de-oiling step, as discussed above. Consequently, the surface of the products has not been subjected to any case hardening, which would cause a crystallised layer of starch on the product surface, which in turn would reduce moisture transmission through the surface layer. Microwave treatment would not cause such case hardening.

Consequently, the preheating step does not cause case hardening and in the subsequent bulk dehydration using explosive dehydration the moisture can readily be uniformly transmitted through the surface, which enhances product uniformity.

The zones and their respective microwave power outputs are configured to achieve controlled preheating of the products at a relatively slow heating rate, which causes any surface moisture to be driven off. The relatively slow heating rate avoids premature explosive dehydration of some initially drier products. Also, the lower microwave power reduces the possibility of arcing occurring on some products which may have a wetter surface, both in the first zone and in the higher energy second zone. The result is that the products leaving the first preheating zone and entering the second cooking zone(s) are uniformly surface-dried and preheated, but not prematurely cooked.

In the second explosive dehydration zone(s), the products are explosively dehydrated at a high drying rate to achieve bulk dehydration and product shrinkage, which reduces any product contact and overlap.

In the third zone the products are dried at a lower rate under reduced power as compared to the second zone(s). This provides uniformly dried products, and the drying can be controlled to achieve a very accurate end point for the moisture, uniformly across the products.

The power outputs in the zones are selected based on the mass flow rate of products, such as potato slices, conveyed through the microwave apparatus 410. The first preheating zone 418 has a microwave power output of from 0.05 to 0.3 kW, optionally 0.1 to 0.15 kW, further optionally about 0.14 kW, per kilogram of products per hour conveyed into the first preheating zone 418. Each second explosive dehydration zone 420, 422 has a microwave power output of from 0.15 to 0.35 kW, optionally 0.2 to 0.3 kW, further optionally about 0.25 kW, per kilogram of products per hour conveyed into the first preheating zone 418. The third drying zone 424 has a microwave power output of from 0.1 to 0.3 kW, optionally 0.15 to 0.25 kW, further optionally about 0.2 kW, per kilogram of products per hour conveyed into the first preheating zone 418.

The first, second and third zones 418, 420, 422, 424 have a total microwave power output of from 0.5 to 1.1 kW, optionally 0.75 to 1.0 kW, further optionally about 0.8 kW, per kilogram of products per hour conveyed into the first preheating zone 418. Typically, the first, second and third zones 418, 420, 422, 424 have a ratio of the microwave power output of about 1:6:2. If there are plural second explosive dehydration zones 420, 422, the microwave power output for the second zone may be divided between the second zones. For example, with two second zones the power outputs may be in a ratio of 1:3:3:2 for the first, second, second and third zones.

Thereafter, the products are dried in the fourth microwave drying zone 450 located downstream of the third zone 424. The fourth drying zone 450 has a fourth power value which is lower than the first microwave power value. The fourth zone 450 has a microwave power output of from 0.4 to 0.12 kW, optionally 0.06 to 0.1 kW, further optionally about 0.08 kW, per kilogram of products per hour conveyed into the first preheating zone 418.

The products are conveyed through the fourth zone 450 at a higher mass flow rate than through the first, second and third zones 418, 420, 422, 424. The products are conveyed through the fourth zone 450 as a second bed of the products, the second bed being deeper than a first bed of the products conveyed through the first, second and third zones 418, 420, 422, 424. This can lower the footprint of the manufacturing line. Since the products have a lower moisture they are less likely be subject to arcing and there is greater moisture uniformity in the product feed entering the fourth zone. Accordingly the mass flow rate can be increased and the product bed on the conveyor may be deepened.

The products entering the first zone 418 have a water content of at least 30 wt % and the products leaving from the third drying zone 424 have a water content of from 10 to 15 wt %, each weight being based on the total weight of the product including the respective water content. The products are conveyed through the first, second and third zones 418, 420, 422, 424 in a period of from 60 to 100 seconds, optionally from 70 to 90 seconds, further optionally about 80 seconds.

The products entering the fourth zone 450 from the third zone 424 have a water content of from 10 to 15 wt % and the products leaving from the fourth zone 450 have a water content of from 5 to 8 wt %, each weight being based on the total weight of the product including the respective water content. The products are conveyed through the fourth zone 450 in a period of from 90 to 180 seconds, optionally from 100 to 150 seconds, further optionally about 120 seconds.

The products are then further dried in the convector drying apparatus 458 downstream of the fourth zone. The products entering the convector drying apparatus 458 have a water content of from 5 to 8 wt % and the products leaving from the convector drying apparatus 458 have a water content of from 1 to 3 wt %, optionally from 1.5 to 2 wt %, each weight being based on the total weight of the product including the respective water content.

In accordance with a further aspect of the invention, it has additionally been found that in order to provide improved flavor and organoleptic properties for the final non-fried potato chip which has been subjected to the lipophilic preconditioning step in oil and microwave explosive dehydration and final drying, the oil content of the de-oiled slices leaving the de-oiler and thus prior to explosive dehydration by the microwave, is 10 to 15 wt % oil or 12.5 wt %+/−2 wt % on a dry basis as explained above and that after the microwave explosive dehydration step, an addition of topical oil after the final drying of the potato chip provides the combination of improved flavor and organoleptic properties. Typically, the topical oil is applied at an amount of 2 wt % based on the weight of the final cooked and dried potato chip after exit from the convector drying apparatus 458 and prior to seasoning. Typically, the potato chip comprises from 10 to 17.5 wt % oil, more typically about 15 wt % oil, based on the weight of the final cooked and dried potato chip prior to seasoning.

### EXAMPLES

The various aspects of the present invention will now be described in greater detail with reference to the following non-limiting Examples.

### Example 1

A potato chip which had been manufactured according to a non-frying process as described hereinabove and had an oil content of 15 wt %, based on the total weight of the potato chip, was tested according to the method of the invention to measure the surface oil of the potato chip, as described with reference to FIG. 2.

In the tissue testing method used in this specification, the weight was 2316.79 g in weight. The weight was composed of a stainless steel body having dimensions of 198 mm long×149 mm wide and 9 mm thick. Such a weight provides that the potato chips were flattened so that all of the surface area of the potato chips was in contact with the tissue, but the potato chips were not crushed.

The tissue comprised a single-ply rolled tissue material available in commerce from Kimberley-Clark Europe, under the product name Wypall® L30 Wipers (Kimberley-Clark Europe Product ID CDS 07303010). The tissue material had a basis weight of 50 g/m² and an oil absorbency capacity of 200 g/m², and an average thickness of 0.3 mm. The tissue material is provided in sheet form having sheet dimensions of 38 cm×20.6 cm. The tissue has a textured side and an untextured side.

During the test, which was carried out at room temperature (20° C.), a sheet of tissue was preliminarily weighed and its weight recorded. Then one end half of the weighed tissue sheet was placed on a planar upper surface of a platen of a digital weighing scale with the textured side of the tissue uppermost. Then the potato chips were placed on the upper surface of the tissue and over the platen of the weighing scale. The other end half of the tissue sheet was folded over to cover the upper surface of the potato chips on the weighing scale, with the textured side of the other end half contacting the upper surface of the potato chips. Then the weight was placed on the upper surface of the other end half of the tissue sheet to flatten the potato chips between the two plies of the tissue. The potato chips and the weight were within the periphery of the platen of the weighing scale, and the potato chips were all between the two tissue plies and covered by the weight.

The flattening was carried out for a period of 15 seconds, after which the weight was removed. The tissue was shaken vigorously to remove any crumbs or debris, and then any remaining debris was blown off using compressed air. The tissue was then weighed and its weight recorded.

Accordingly, a sample of potato chips weighing 4 grams was disposed in the form of a central layer between opposed upper and lower layers of paper tissue. The tissue material had been pre-weighed to determine its mass. The potato chips were laid out in a non-overlapping configuration. A 2.31679 kg flat weight was laid on the assembly to apply a uniform pressure to the assembly of layers. This flattened the potato chips onto the inwardly directed tissue surfaces, and the applied pressure caused surface oil on the potato chips to be transferred and absorbed onto the opposed layers of tissue material.

The potato chips were then removed from the tissue material, and an air blower was used to release any potato chip debris from the tissue surfaces. The tissue material was then weighed to determine a weight of oil deposited onto the tissue material from the potato chips. Twenty samples of the same batch of potato chips were tested and an average result determined. Assuming that the weight of oil deposited onto the tissue material represented the free surface oil on the potato chips, the determined weight was employed, together with the oil content value of 15 wt %, to calculate the percentage of the total oil in the potato chips which was present as free surface oil

The results are shown in Table 1.

TABLE 1

| | | Oil collected on | |
|---|---|---|---|
| | Oil content of | tissue per 100 g | % of oil as free |
| | potato chips - | of potato chips - | surface oil - |
| | wt % | g | % |
| Example 1 | 15 | 0.10 | 0.68 |
| Comparative | 11.8 | 0.25 | 2.11 |
| Example 1 | | | |
| Comparative | 22 | 0.55 | 2.51 |
| Example 2 | | | |
| Comparative | 25 | 0.35 | 1.39 |
| Example 3 | | | |
| Comparative | 33 | 0.8 | 2..42 |
| Example 4 | | | |

It may be seen that for an oil content of 15 wt %, only 0.68% of the oil was present as free surface oil and only 0.10 grams of oil was collected on the tissue per 100 grams of potato chips

### Comparative Examples 1 to 4

Commercially available potato chips which had been manufactured according to various cooking processes were similarly tested to determine their respective surface oil content.

The potato chip of Comparative Example 1 was a baked Kettle® potato chip manufactured by Kettle Foods Limited, UK, having an oil content of 11.8 wt %. That potato chip is baked rather than fried and so has a lower oil content than conventional fried potato chips, which is typically from 30 to 35 wt %, such as about 33 wt %.

The potato chip of Comparative Example 2 was a Red Sky® potato chip manufactured by Walkers Snack Foods Limited, UK, having an oil content of 22 wt %. The Red Sky potato chip was continuously fried in a kettle, which reduces the oil content as compared to conventional fried potato chips.

The potato chip of Comparative Example 3 was a Walkers Lights® potato chip manufactured by Walkers Snack Foods Limited, UK, having an oil content of 25 wt %. The Walkers Lights potato chip was fried.

The potato chip of Comparative Example 4 was a Walkers® potato chip manufactured by Walkers Snack Foods Limited, UK, having an oil content of 33 wt %. The Walkers potato chip was conventionally fried.

The results are also shown in Table 1. It may be seen that for the potato chips of all of the four Comparative Examples, the percentage of the oil present as free surface oil and the weight of oil collected on the tissue per 100 grams of potato chips were both consistently higher than for the potato chips of Example 1. This is despite that fact that, for example, the baked potato chips of Comparative Example 1 had a lower oil content (11.8 wt %) than the oil content (15 wt %) of the potato chips of Example 1.

In other words, the potato chips of the present invention exhibited a lower proportion of free surface oil, which is of significant benefit to consumer appeal. The potato chips of the present invention will tend to leave less oil on the fingers of a consumer when eating the potato chips.

In taste tests, the potato chips exhibited a taste sensation and organoleptic properties which were at least as acceptable to the consumer as conventional fried potato chips, and in fact were improved by being less oily.

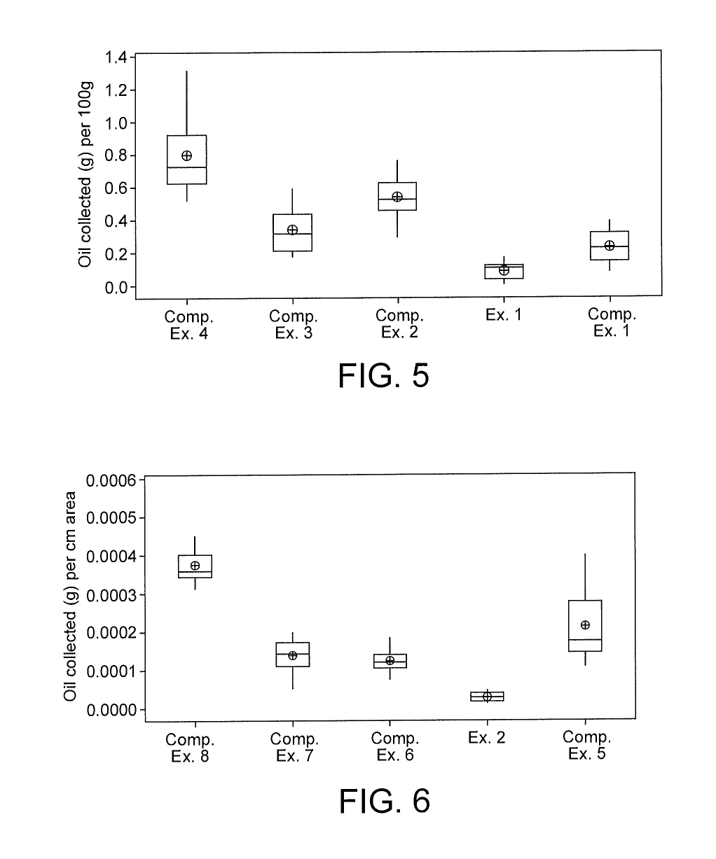

FIG. 5 shows the amount of oil collected on the tissue per 100 grams of potato chips for each of Example 1 and Comparative Examples 1 to 4 as a “boxplot”, indicating the range of maximum and minimum measurements for the twenty samples. It may be seen that the potato chips of Example 1 had a more uniform surface oil content as compared to Comparative Examples 1 to 4. This shows that consumer acceptance of the potato chips of the invention is likely to be higher due to reduced product variation from batch to batch.

### Example 2

The same potato chip as tested in Example 1 was packaged within a conventional bag of flexible polymeric film. The bag was tested to measure the amount of oil deposited on an inside surface of the bag containing the potato chips, which inside surface had oil deposited thereon by transfer from a portion of the oil on a surface of the potato chips. The test was according to the method of the invention to measure the amount of oil deposited on an inside surface of the bag, as described with reference to FIG. 4.

A sealed bag which contained a plurality of potato chips was opened and the potato chips were removed. The bag was fully opened to expose the entire inside surface of the bag. Then the entire inside surface was wiped three times in succession, each time with a respective swab of cotton wool, to transfer oil from the inside surface to the swab. Then, using a Soxtec extraction method, the oil was extracted from the swabs and then the extracted oil was weighed. The weight of the oil and the known surface area of the inside surface were then employed to calculate the weight of oil per unit area of the inside surface.

These method steps were repeated on twenty five samples of the sealed bag to obtain an average weight per bag of oil per unit area of the inside surface.

The results are shown in Table 2.

TABLE 2

| | | Oil collected from | % of oil |
|---|---|---|---|
| | Oil content of | bag inside surface | content on bag |
| | potato chips - | per unit area - | inside surface - |
| | wt % | 10⁻⁶ g per cm² | % |
| Example 2 | 15 | 16 | 0.24 |
| Comparative | 11.8 | 200 | 1.59 |
| Example 5 | | | |
| Comparative | 22 | 115 | 0.66 |
| Example 6 | | | |
| Comparative | 25 | 133 | 0.88 |
| Example 7 | | | |
| Comparative | 33 | 368 | 1.78 |
| Example 8 | | | |

It may be seen that for an oil content of 15 wt %, only 0.24% of the oil content was deposited on the inside surface of the bag and only 16×10⁻⁶ g of oil was deposited on the inside surface of the bag per cm² of the inside surface area.

### Comparative Examples 5 to 8

The packaged potato chips of Comparative Examples 5 to 8 were the same commercially available potato chips as respectively used for Comparative Examples 1 to 4, with each potato chip being packaged in the respective commercially available bag. The bags of these commercially packaged potato chips were similarly tested according to the same test as for Example 2.

The results are also shown in Table 2. It may be seen that for the potato chips of all of the four Comparative Examples 5 to 8, the percentage of the oil deposited onto the bag inside surface, which is representative of free surface oil, and the weight per unit area of oil collected from the bag inside surface, were both consistently higher than for the potato chips of Example 2. Again, this is despite that fact that the baked potato chips of Comparative Example 5 had, for example, a lower oil content (11.8 wt %) than the oil content (15 wt %) of the potato chips of Example 2.

In other words, the potato chips of the present invention exhibited a lower proportion of free surface oil, which is of significant benefit to consumer appeal, which means that when packaged in a conventional flexible snack food bag, less oil is wastefully deposited on the inside surface of the bag.

FIG. 6 shows the amount of oil collected per unit area of the inside surface of the bag for each of Example 2 and Comparative Examples 5 to 8 as a “boxplot”, indicating the range of maximum and minimum measurements for the twenty five samples. It may be seen that the potato chips of Example 2 had a more uniform oil content on the bag surface as compared to Comparative Examples 5 to 8. This shows that consumer acceptance of the potato chips of the invention is likely to be higher due to reduced product variation from batch to batch.

By reducing the oil residue on the inside surface of the snack food bags, significant economical and environmental advantages can be achieved. For example reduced oil residue reduces the cost and complexity of bag recycling. In addition, by reducing the amount of excess vegetable oil used during the potato chip manufacturing process, because a reduced amount of oil is deposited on the bag inside surface, this can yield significant savings in carbon dioxide emissions from the manufacturing process. As shown in Table 3, for the packaged potato chips of each of Comparative Examples 5 to 8, these each exhibit a greater carbon footprint, and generate greater CO₂ emissions, than the packaged potato chips of Example 2.

TABLE 3

| | CO₂ loss from increased |
|---|---|
| | oil usage during manufacture - |
| | mg CO₂ per g of potato chip |
| Example 2 | 0 (Baseline) |
| Comparative Example 5 | 1.70 |
| Comparative Example 6 | 1.16 |
| Comparative Example 7 | 2.11 |
| Comparative Example 8 | 6.31 |

1. A potato chip comprising a cooked potato slice and from 5 to 20 wt % oil based on the weight of the potato chip, wherein the oil comprises a first oil portion within the cooked potato slice and a second oil portion on the surface of the cooked potato slice, the second oil portion comprising no more than 0.2 wt % of the weight of the potato chip.

2. A potato chip according to claim 1, wherein the second oil portion comprises from 0.05 to 0.2 wt % of the weight of the potato chip.

3. A potato chip according to claim 2, wherein the second oil portion comprises from 0.05 to 0.15 wt % of the weight of the potato chip.

4. A potato chip according to claim 3, wherein the second oil portion comprises about 0.1 wt % of the weight of the potato chip.

5. A potato chip according to claim 1, wherein the potato chip comprises from 10 to 17.5 wt % oil based on the weight of the potato chip.

6. A potato chip according to claim 5, wherein the potato chip comprises about 15 wt % oil based on the weight of the potato chip.

7. A potato chip according to claim 1, wherein the first oil portion comprises more than 99 wt % of the total oil content of the potato chip and the second oil portion comprises less than 1 wt % of the total oil content of the potato chip.

8. A potato chip according to claim 7, wherein the first oil portion comprises from 99.25 to 99.75 wt % of the total oil content of the potato chip and the second oil portion comprises from 0.25 to 0.75 wt % of the total oil content of the potato chip.

9. A potato chip according to claim 1, packaged in a package composed of a transparent material, optionally a bag composed of a transparent flexible film.

10. A bag of potato chips, wherein the bag comprises a sealed bag of flexible material and contains a plurality of potato chips, each potato chip comprising a cooked potato slice and from 5 to 20 wt % oil based on the weight of the potato chip, wherein an inside surface of the bag has oil deposited thereon by transfer from a portion of the oil on the surface of the cooked potato slices, the weight of oil on the inside surface being no more than 100×10⁻⁶ grams/cm² of the inside surface.

11. A bag of potato chips according to claim 10, wherein the weight of oil on the inside surface is from 5×10⁻⁶ to 50×10⁻⁶ grams/cm² of the inside surface.

12. A bag of potato chips according to claim 11, wherein the weight of oil on the inside surface is from 10×10⁻⁶ to 25×10⁻⁶ grams/cm² of the inside surface.

13. A bag of potato chips according to claim 10, wherein from 0.1 to 0.5 wt % of the total oil content of the potato chips is on the inside surface.

14. A bag of potato chips according to claim 13, wherein from 0.15 to 0.25 wt % of the total oil content of the potato chips is on the inside surface.

15. A bag of potato chips, wherein the bag comprises a sealed bag of flexible material and contains a plurality of potato chips, each potato chip comprising a cooked potato slice and from 5 to 20 wt % oil based on the weight of the potato chip, wherein an inside surface of the bag has oil deposited thereon by transfer from a portion of the oil on the surface of the cooked potato slices and from 0.1 to 0.5 wt % of the total oil content of the potato chips is on the inside surface.

16. A bag of potato chips according to claim 15, wherein from 0.15 to 0.25 wt % of the total oil content of the potato chips is on the inside surface.

17. A bag according to claim 10, wherein the flexible material is a transparent film.

18.-30. (canceled)

31. A method of manufacturing potato chips, the method comprising the steps of:
(a) conveying potato slices through a reservoir of oil contained in a tank, the potato slices being conveyed using an elongate conveyor defining therealong a plurality of compartments for containing respective groups of potato slices;
(b) injecting oil into the reservoir from at least one oil jet located on the tank, the injected oil causing turbulent flow in the reservoir of oil and agitation of the potato slices in the oil;
(c) removing the potato slices from the reservoir of oil;
(d) removing surface oil from the potato slices;
(e) conveying the potato slices through a flat bed microwave apparatus, the microwave apparatus being configured to define a plurality of successive independent microwave zones between the upstream and downstream ends of the microwave apparatus, each zone having a respective microwave attenuator at an upstream inlet and at a downstream outlet of the respective zone;
(f) preheating the potato slices in a first preheating zone located towards an upstream end of the microwave apparatus, the first zone having a first microwave power value;
(g) explosively dehydrating the products in at least one second explosive dehydration zone located downstream of the first preheating zone, the explosive dehydration drying a body of the potato slices at a first drying rate, the second zone having a second microwave power value higher than the first microwave power value; and
(h) drying the potato slices in a third drying microwave zone located downstream of the at least one second explosive dehydration zone.

32. A method according to claim 31, wherein the conveyor comprises a rotating drum having a helical auger mounted therein, the auger defining successive compartments within the reservoir of oil.

33. A method according to claim 31, wherein plural oil jets provide a continuous agitation of oil and the potato slices conveyed along the tank.

34. A method according to claim 31,
wherein the at least one oil jet directs oil into the tank at a velocity of from 5 to 20 metres/second.

35. A method according to claim 31, wherein an oil flow through the at least one jet has an oil pressure of from 1×10⁻³ to 10×10⁻³ N/m².

36. A method according to claim 31, wherein between steps (c) and (d) the potato slices in the oil are flowed over a flume device to broaden the flow of potato slices, by:
(A) pumping a supply of the oil containing the potato slices into a gulley of a flume device;
(B) flowing the potato slices in the oil from a downstream end of the gulley into a downwardly inclined fishtail ramp of the flume device, the fishtail ramp having opposed lateral walls and progressively increasing in width from an upstream end to a downstream end of the fishtail ramp, the downwardly flowing potato slices progressively spreading across the width of the fishtail ramp; and
(C) discharging the potato slices in the oil onto a conveyor from a discharge chute connected to the fishtail ramp, wherein the oil flow velocity through the flume device is up to 10 m/s.

37. A method according to claim 36, wherein the weight of the potato slices in the flow through the flume device is from 0.5 to 3 wt % of the weight of the oil in the flow through the flume device.

38. A method according to claim 31, wherein in step (d) the potato slices are de-oiled by a method comprising the steps of:
(i) randomly feeding the potato slices onto an elongate longitudinal conveyor which is permeable to oil, water and air;
(ii) spraying water downwardly and upwardly from respective upper and lower water spray units onto the plurality of potato slices on the conveyor to cause the water to displace and lift surface oil on the potato slices; and
(iii) thereafter directing upper and lower air blades downwardly and upwardly, respectively, onto the plurality of potato slices on the conveyor to cause the air blades to blow a mixture of oil and water from the potato slices, wherein the air blades comprise a plurality of pairs of upper and lower air blades spaced along the conveyor.

39. A method according to claim 38, wherein in step (i) the potato slices are fed onto the conveyor in a substantially non-overlapping configuration.

40. A method according to claim 38, wherein the upper and lower water spray units are adapted each to spray from 0.72 to 1.2 litres of water per hour per kg of potato slices per hour, towards the conveyor.

41. A method according to claim 38, wherein the air blades have an air velocity of from 30 to 60 metres per second.

42. A method according to claim 38, further comprising the step, between steps (i) and (ii), of directing at least one primary air blade downwardly towards the potato slices on a primary conveyor.

43. A method according to claim 42, wherein the primary air blade has an air velocity of from 30 to 60 metres per second.

44. A method according to claim 38, wherein in step (i) the potato slices have an oil content of about 30 to 45 wt % oil, based on the dry weight of the final potato chip produced from the potato slice, and the potato slices after being de-oiled in step (iii), have an oil content of about 10 to 15 wt % oil, based on the dry weight of the final potato chip produced from the potato slice.

45. A method according to claim 31, wherein in each of the second zones the second microwave power value is from 1.25 to 5 times, higher than the first microwave power value.

46. A method according to claim 31, wherein in all of the second zones the total second microwave power value is from 2 to 8 times, higher than the first microwave power value.

47. A method according to claim 31, wherein the third drying zone has a third microwave power value and the second microwave power value is higher than the third microwave power value.

48. A method according to claim 47, wherein the third drying zone has a third microwave power value and the second microwave power value is from 1.1 to 2 times, higher than the third microwave power value.

49. A method according to claim 31, wherein the third drying zone has a third microwave power value and the third microwave power value is higher than the first microwave power value.

50. A method according to claim 49, wherein the third microwave power value is from 1.5 to 2.5 times, higher than the first microwave power value.

51. A method according to claim 31, wherein the first preheating zone has a microwave power output of from 0.05 to 0.3 kW, per kilogram of products per hour conveyed into the first preheating zone.

52. A method according to claim 31, wherein the second explosive dehydration zone has a microwave power output of from 0.15 to 0.35 kW, per kilogram of products per hour conveyed into the first preheating zone.

53. A method according to claim 31, wherein there are two successive second explosive dehydration zones, each having a respective second microwave power value.

54. A method according to claim 31, wherein the third drying zone has a microwave power output of from 0.1 to 0.3 kW, per kilogram of products per hour conveyed into the first preheating zone.

55. A method according to claim 31, wherein the first, second and third zones have a total microwave power output of from 0.5 to 1.1 kW, per kilogram of products per hour conveyed into the first preheating zone.

56. A method according to claim 31, wherein the first, second and third zones have a ratio total microwave power output of about 1:6:2.

57. A method according to claim 31, further comprising step (j), after step (h), of drying the products in a fourth microwave drying zone located downstream of the third zone.

58. A method according to claim 57, wherein the fourth drying zone has a fourth microwave power value which is lower than the first microwave power value.

59. A method according to claim 58, wherein the first microwave power value is from 1.25 to 2.5 times, higher than the fourth microwave power value.

60. A method according to claim 57, wherein the fourth zone has a microwave power output of from 0.4 to 0.12 kW, per kilogram of products per hour conveyed into the first preheating zone.

61. A method according to claim 57, wherein the fourth zone is defined by a second flat bed microwave apparatus.

62. A method according to claim 57, wherein the products are conveyed through the fourth zone at a higher mass flow rate than through the first, second and third zones.

63. A method according to claim 57, wherein the products are conveyed through the fourth zone as a second bed of the products, the second bed being deeper than a first bed of the products conveyed through the first, second and third zones.

64. A method according to claim 57, wherein the products are conveyed through the fourth zone in a period of from 90 to 180 seconds.

65. A method according to claim 57, wherein the products entering the fourth zone have a water content of from 10 to 15 wt % and the products leaving from the fourth zone have a water content of from 5 to 8 wt %, each weight being based on the total weight of the product including the respective water content.

66. A method according to claim 57, further comprising a convector drying apparatus for drying the conveyed products downstream of the fourth zone.

67. A method according to claim 66, wherein the products entering the convector drying apparatus have a water content of from 5 to 8 wt % and the products leaving from the convector drying apparatus have a water content of from 1 to 3 wt %, each weight being based on the total weight of the product including the respective water content.

68. A method according to claim 31, wherein the products entering the first zone have a water content of at least 30 wt % and the products leaving from the third drying zone have a water content of from 10 to 15 wt %, each weight being based on the total weight of the product including the respective water content.

69. A method according to claim 31, wherein the products are conveyed through the first, second and third zones in a total period of from 40 to 100 seconds.

70. A method according to claim 31, wherein the products are conveyed through the first, second and third zones without product cooling.
